(19) United States
(12) Patent Application Publication
(10) Pub. No.: US 2007/0214120 A1
(43) Pub. Date: Sep. 13, 2007

(54) System and Method for Electronic Processing of Title Records

(75) Inventor: Carl A. Niendorff, Dallas, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Barrett Burke Wilson Castle Daffin & Frappier LLP, Addison, TX (US)

(21) Appl. No.: 11/679,974

(22) Filed: Feb. 28, 2007

Related U.S. Application Data
(60) Provisional application No. 60/780,237, filed on Mar. 8, 2006.

(51) Int. Cl. G06F 17/30

(52) U.S. Cl. 707/3

(57) ABSTRACT

A system and method is disclosed for automated processing of large volumes of title record case files for paperless transfer, review, and storage of documents. The incoming case files may be received in electronic or paper form. The invention also provides a means for electronic processing, review, and analysis of title records. Imaging is performed by indexing all documents as digital images relative to a specific case file, such that querying for accessing the case file is greatly simplified. The processes comprising case origination, electronic review, curative distribution, and imaging/indexing can be performed at any location with network access to the database, without detracting from the high efficiency and quality of the processes performed. The invention also provides for electronic and manual interfaces for outgoing or incoming documents, notices, and correspondence, in paper or electronic form.

### RELATED APPLICATION

The present application claims priority to a U.S. Provisional Patent Application No. 60/780,237, entitled SYSTEM AND METHOD FOR ELECTRONIC PROCESSING OF TITLE RECORDS, filed Mar. 8, 2006. The provisional patent application is incorporated herein by reference in its entirety for all purposes.

### FIELD OF THE INVENTION

The present invention relates generally to automated document processing systems and thereto related business process methods. In particular, the present invention relates to electronic search and analysis of title records.

### BACKGROUND OF THE INVENTION

The interest in and transfer of ownership related to real property is generally recorded by local governments, with administration typically performed at the county level. A property owner may transfer an interest in her property by recording a document as evidence of the transfer. This well known practice provides public notice of who owns what interest in all real property of each county. There may be various types of rights transferred in a title transaction which impart various degrees of interest and ownership in a property. An outright sale of the property by the owner may transfer all rights previously held by the seller to a buyer, which is generally recorded in a deed. A creditor may record a lien on real property owned by the borrower in certain situations. For example, a county government may record a tax lien on a property if property taxes owed on that property are not paid in a timely manner. In another case, a mortgagee may obtain the right to foreclose on a property owned by the mortgagor.

A foreclosure is a legal procedure whereby a lender gains title or sells a borrower's real (and sometimes personal) property after the borrower fails to honor the terms of a financial lien instrument, normally involving regular, i.e., monthly, payments to repay her debt. The foreclosure process thus begins when a borrower defaults on loan payments.

During an initial grace period, known as pre-foreclosure, the borrower is given written notice of the default and provided an opportunity to pay the amount in default. If the borrower remains in default beyond a certain period, for example 30-60 days, the lender may accelerate the repayment of the indebtedness and file a notice of public sale of the real property or the filing of a judicial action. In practice, foreclosure in the U.S.A. is governed by state laws and involves procedures for the lender and borrower that may be different in each state.

Whatever the terms, after a certain period of time, depending on the particulars of the lien instrument and the specific state law requirements, if a borrower has not repaid the amounts in default, the loan repayment may be accelerated by the lender and the lender may foreclose on the property to try to satisfy the outstanding indebtedness owed on the underlying loan documents. An acceleration letter will be sent to the borrower requesting all outstanding principal and all accrued and unpaid interest, plus other costs and expenses, to the extent recoverable by applicable law. This amount is to be paid by a specified date. If the amount is not paid by such date, foreclosure proceedings may begin with the ultimate goal of selling the real property to cover the loan.

Despite the public administration of real property records by county governments, clarification of the situation with respect to legal rights to and interest in a given real property may not simply be taken for granted. Title recording systems lack standardization and are prone to remarkable errors. Traditionally, hand-written ledgers were chronologically recorded by county clerks indexed by grantor-grantee transfers. There may have been no requirement for indexing by the land parcel, which aggravates searching when all records for a given parcel must be obtained. For a grantee to obtain an interest in a property from a grantor, the grantee must be assured that the grantor actually possesses the interest being transferred, free from conflicting or potential encumbrances. For this purpose, title companies provide assurance in the form of a title insurance policy, that insures a grantee against the risk of obtaining a legally defective interest in a property. This type of title policy is known as an owner's title insurance policy. A loan title insurance policy (e.g., mortgage policy) insures a lender against similar title risks associated with real property recorded as collateral for a loan, typically a mortgage. These kinds of title insurance policies cover title risks at the time a property is sold and a mortgage lien is recorded. If the mortgagor defaults on her loan, and the mortgagee initiates foreclosure proceedings, the mortgagee (and any potential buyer) is again faced with title risks from encumbrances that may have been recorded in the name of the mortgagor since the last title policy was issued, in addition to previous title risks that may not have been adequately resolved.

In order to determine the actual state of a title record for a given real property, a title analysis is conducted. The commercial process usually begins with an order to a service provider to retrieve and analyze a given title. Depending on the purpose of the order, the search and analysis requirements may vary. In one example, a title company may request information required for underwriting a title insurance policy. In another case, a mortgagee may want to evaluate the quality of the collateral associated with a mortgage. In the case of foreclosure, a mortgagee performs a title search to assess the present condition of the title records for a property whose mortgagor is in default, in view of a sale. In particular, the mortgagee may need to determine the presence and condition of any encumbrances on the title that may potentially stand adverse to a foreclosure sale.

Once the order for a title analysis is issued, the entity servicing the request will begin the process of retrieving and collating the title records for the given property. These title records are generally public documents, administered by a county-level government entity. In recent years, certain private firms have begun offering electronic access to title record databases as a commercial service. Depending on the state and county, this may require that an abstractor obtain a paper copy of certain records from a county courthouse. The analysis continues with an examination of all title documents. If unresolved issues are found, a detailed list of title problems may be generated for documentation. Depending on the particularities of the case, the title issues may be curatively resolved, require action by an attorney, or give rise to litigation.

The process of assembling the title records and other documents associated with a foreclosure title order generates a case file for that order. After the case file has been opened, all further processing steps, such as certifying a searched through date, certifying a courthouse records date, or performing an examination, are performed with the documents physically coupled to that case file. Traditionally, these case files have been retained in paper form, and are stored, for example, in large open-well files or buckets that may contain multiple documents concerning a client or customer. For example, these large paper files or buckets are often stored on small mobile carts with many buckets, on shelves, or are archived in storage (on or off-site). As the volume of cases processed within an organization grows, the efficiency and quality of the processing may suffer significantly with paper-based case files, while requiring a disproportional amount of work for organization and tracking of cases and workflow.

Typically, commercial title service departments have to manually process and manage literally tens of thousands of case related documentation. Often times this documentation comprises content specific information that is most often tied to short processing and mailing deadlines to meet certain U.S. laws, District and Local Court Rules, clients expectations and internal standards. In time-consuming prior art methods, document clerks received paper files, manually logged them and forwarded them to appropriate personnel for specific action. Once at the proper qualified processor, reviews and decisions were made to determine if the file was complete and accurate before forwarding to the next processing step for completion. If documentation in the paper case file was missing, a request for additional documentation was issued and supplementary documents were added to the file. However, as the number of files processed increased, the potential for error and loss of documents often constrained the productivity of the available human resources, as error rates required enormous remediation effort. Often large quantities of documentation would cause tremendous backlog and would cause an inordinate amount of man-hours spent clearing the queue. In addition, the manual system allowed for very little extensive, if any, quality analysis of the data contained therein. Often managers of these firms had little control over the data and outcomes, and could never be sure whether they were properly being handled. It was not until deadlines were not met or bills were not being timely paid that specific situations would come to light.

For example, in the case of a title services company, multiple areas of such time sensitive and content specific information may include a client identification number, a matter identification number, correspondence, communications, personal and corporate entities associated with the matter or client, as well as important documents and/or information associated with a client or customer. The successful organization of such large volumes of information becomes problematic, especially when in paper form. For example, in paper form such information may take the form of a fully stuffed expandable folder. If the information is voluminous, it may take the form of several expandable folders, which must then be tracked individually and collectively as a case. Consequences of such voluminous information include the difficulty of ease of physical access, inventory issues, data management and loss problems.

Modern databases are often used to organize such information, thereby making retrieval quicker and easier, and thereby utilizing less physical space for storage. In addition, the use of networked interfaces is well-known and allows access to these databases by multiple users. Controlled access may be provided to the multiple users by the use of security passwords, for example, which limit the availability of data to authorized individuals. However, although it is conceptually simple to “store and retrieve” information from a database, the generation of specific documents, such as time sensitive and content specific information, the general organization and management of specific data within the database, and practical access to such information, have proven to be great hurdles for computerizing these kinds of workflow processes.

Previous attempts using digital imaging to create paperless business processes have often failed to achieve their goals, due to ineffective methods and cumbersome data structures in the implemented solution, which may have been a result of an incomplete understanding of the problem. For example, the organization of image files in a single database of images indexed by the type of document, as is predominately found in commercial image processing solutions, does not meet the workflow requirements of a transactional or case file based process, such as title record analysis processes. Often the result of so-called automated processing systems has actually meant an increase in the amount of paper and manual organization of documents, which contributed to an overall increase in the amount of work required to perform a task. In one example, a computerized tracking system operated in conjunction with previous paper case file methods, in order to preserve existing processes and minimize disruption. However, the resulting workload for manually entering tracking and status details for each case file only compounded a shortage of labor resources and introduced many more sources of error, thereby only marginally providing any new benefits for controlling and reporting. Such negative experiences and business risks have deterred many potential applications of automated processing systems.

Previous attempts at performing an automated title search and examination have proposed a solution requiring the acquisition and digitization of all title records into a database of records with searchable fields. Although such an electronic database of title records promises to deliver advanced search and examination functions, this kind of approach fails to accommodate practical constraints inherent to the endeavor. For one, the lack of standardization in title documents and title records renders a standardization in database form nearly impossible, and impractical, until there is standardization in the industry. Further, a database of all title records must be continually updated in real-time to serve the stated purpose; the required maintenance effort after the database goes online is however commercially prohibitive, until systems are in place to automatically generate and modify records electronically, and such systems are seamlessly integrated together. The scope and political nature of such dependent project phases render them highly unlikely within a commercially viable time frame. Considering that harmonization of title records must occur at a county level underscores the enormous challenge and time scale associated with such a project. Other prior art methods have established a methodology for quantifying the state of title records of a real property using a numeric scoring system for reporting the results of a title examination. However, title-scoring methods are not considered commercially practical because each particular encumbrance which may affect an interest in the property would be considered a potential obstacle to a sale. Further, curative procedures for removing potential encumbrances on a title record would require an exact description and specification of the encumbrance be reported, and not just a single numeric value which represents a class of issues.

If title case information were available such that separately stored but related data was available in an easily searched, accessed, and manipulated form, then an improved ability to utilize this data would increase the efficiency of a professional attempting to analyze the information. Therefore, a need exists for a system that provides universal information access and viewing capability relating to a specific case, and that allows for the accessing and manipulation of identification and characterization information, related documents, records of professional services rendered, correspondence, communications, and other personal and corporate entity information associated with a case file. The requirements of such a solution would include the ability to interface with both electronic and paper-based sources of title records, while providing for human oversight with transparent automation of document management and handling. The solution should be able to report issues found in a title record analysis, and transmit these with all necessary information to curative entities for further processing. A need additionally exists for such a universal system to provide a comprehensive technique to allow simple access to information of varying complexity and format via a single, simple to use interface.

### SUMMARY OF THE INVENTION

The present invention addresses the foregoing needs by providing an automated system and method that has been proven effective in drastically increasing efficiency and reducing errors in the processing of title search requests and title analyses in support of foreclosures. The present invention also provides for electronic ordering of title requests stemming from a pending foreclosure, including electronic submission of all information and documents related to the request. The present invention also provides for electronic disbursement of the results of a title analysis. The results, in the form of unresolved issues accompanied by a complete electronic documentation of the title analysis, may be electronically disbursed to those entities within the receiving organization that are responsible for resolving the issues. The same results may alternatively be reported in printed form after electronic title analysis has been performed.

The present invention provides a system and method for automatically processing, managing and generating title record case file related information and documentation of virtually any document generated by an office without the need for pre-printed forms, and, more particularly, to streamlining overall title record case file information and processes via computer implemented software for use by professionals and staff for the management of the submission, evaluation, analysis, production and generation of letters and documents regarding individual case files. Although much publicity has been given to the idea that widespread use of computers would usher in an age of the “paperless office” or “electronic office,” for the most part such predictions have yet to be realized because certain inadequacies of current computer technology prevent available systems from achieving this potential. By addressing and overcoming these inadequacies, the present invention permits the implementation of a computer system having software which can truly be said to achieve the primary goals of various paperless and/or electronic office automation areas. In particular contrast to prior art methods of title examination, the present invention follows a middle path between full-scale automation of all data collection and analysis functions on one hand, and manual tasks performed by a human expert on the other hand; it is the judicious and synergetic combination of automation coupled with integration of manual activity that make the invention unique in its practicality, and so, commercially viable for processing large volumes of case files.

The present invention is based on a large centralized database server that can manage the requirements of digital imaging of all title record case files and their related documents. The database server is networked to all other components in the system, comprising network-client workstations, network printers, network scanners, and other document processing equipment. The networked system can be equipped with high level security, such as encryption and protection from malicious code, commensurate with the requirements of a financial institution, such as a bank or a mortgage lender. Further components of the present invention comprise components which are operative to interface with external entities, such as clients of a law firm, courts, financial institutions, government offices, as well as billing and archiving systems. The components may allow for interfacing to external systems to be performed manually, with the help of data processing software, via Internet websites, or fully automatically with the use of 3rd party middleware software packages.

One aspect of the present invention involves methods for ordering a title search. The purpose of this functional method is to control the actual ordering of the title itself. This may encompass locating of cases that need orders, identification of the type of orders needed, as well as the updating of various case data elements designating that the order was made. This is the initial phase of the title analysis process.

Another aspect of the present invention involves activities related to title abstracting. This functional method will involve the actual review of the title order. Included in this review will be the retrieval and review of title related documents and borrower information. This will involve either the process of obtaining the pertinent document and borrower information directly from public records or through external vendors. At the conclusion of this phase, the user will be required to complete a comprehensive questionnaire designed to capture any known issues. Theses issues and related documents will serve as input into the title analysis functional method.

Thus another aspect of the present invention involves method for analysis of title records and documents. The analysis process involves the reviewing of title issues identified in the abstraction phase as well as addressing additional potential title issues. Orders that have been abstracted internally or externally may use the same analysis process. An important element in the title analysis method is improved efficiency in the processing of title orders by combining the abstracting and examination roles into a single operation that may be performed by the same individual.

Another aspect of the present invention involves curative processes to resolve the issues found with title during the abstraction and examination phases. The curative processes may involve correction of records, or forwarding the case file (including all linked information and documents) to an attorney for further legal action, or even litigation.

An object of the present invention is to provide an automated system and process for performing the work associated with title analysis case files.

Another object of the present invention is to provide a system and method for processing large volumes of title analysis case files in a highly automated manner.

Another object of the present invention is to provide a practical method for digital imaging of all necessary documents relating to a particular title analysis case file and seamlessly integrating the storage of and access to required documents in the automated system and process.

Another object of the present invention is to provide a system and method for accessing title analysis case files via an index file that serves as an electronic reference to the documents in the case file.

Another object of the present invention is to provide a method and system for review of title analysis case files and all necessary documentation, in completely paperless form, while ensuring that all documents remain secure and properly indexed to their associated case.

Another object of the present invention is to provide reliable interfaces to external entities, for example clients, attorneys, external vendors, and billing or archiving systems, through their administrative operations, such that bidirectional transfer of title analysis case files and associated data is performed automatically and fully integrated into the automated processing of the case files.

Another object of the present invention is to seamlessly integrate in the system and methods a plurality of business rules for determining client preferences, document processing steps, filing procedures, assignment of processing priorities, consideration of mandatory deadlines, title analysis procedures and any other specific functions which must be performed in dependence to established criteria.

At least one of the preceding objects is met, in whole or in part, by the present invention. The foregoing has outlined broadly the more important features of the invention to better understand the detailed description that follows, and to better understand the contribution of the present invention to the art. As those skilled in the art will appreciate, the conception on which this disclosure is based readily may be used as a basis for designing other structures, methods, and systems for carrying out the purposes of the present invention. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The foregoing summary as well as the following detailed description of embodiments of the invention will be better understood when read in conjunction with the appended drawings. It should be understood, however, that the invention is not limited to the precise arrangements and methods shown herein. The elements in the drawings are not necessarily shown in ultimate detail, emphasis instead being placed on clearly illustrating the principles of the present invention. Moreover, in the drawings, like reference numerals designate corresponding parts throughout the several views.

The invention may take physical or logical form in certain parts and arrangement of parts. For a more complete understanding of the present invention, and the advantages thereof, reference is now made to the following descriptions taken in conjunction with the accompanying drawings, in which:

FIGS. 1A and 1B illustrate an overview of system components and functional modules embodied by the present invention;

FIG. 2 illustrates an architectural diagram of an embodiment of the present invention;

FIG. 3 illustrates a method flowchart of an embodiment of the present invention;

FIG. 4 illustrates a high-level architectural diagram of the modules in one embodiment of the present invention;

FIGS. 4A-4F illustrate functional details in embodiments of the present invention;

FIG. 5 illustrates methods in one embodiment of the present invention; and

FIGS. 6-30 illustrate examples of user interface panels for a foreclosure title analysis process in an embodiment of the present invention.

### DETAILED DESCRIPTION

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. These and other objects, features and advantages of the present invention will be more readily apparent when considered in connection with the following, detailed description of embodiments of the invention, which description is presented in conjunction with annexed drawings below.

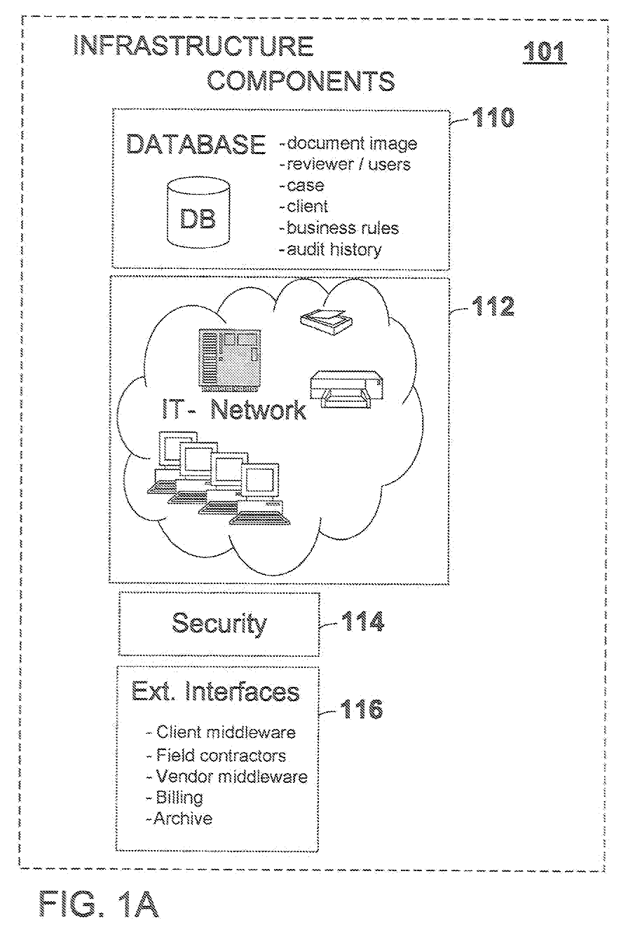

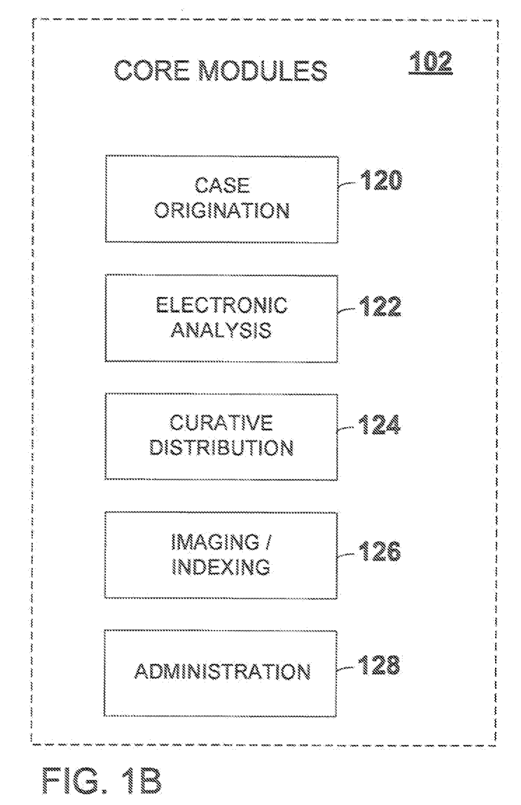

Referring now to FIG. 1A, the infrastructure components 101 of an implementation of the present invention as a computer program product and data processing system are illustrated. The system architecture of the present invention is based on a large centralized database server 110 that can manage the requirements of digital imaging of all title record case files and all required related documents. The database 110 contains records of all users and their access rights, such as those persons qualified to perform electronic analysis and abstraction of title records. The central database 110 contains records pertaining to clients, including their billing information, interfacing requirements, and document preferences. The database 110 also contains tracking records of time stamped events and actions taken on the system by operators, with indexing to individual case files, for generating an audit history. In one example case, the tracking records are used to determine performance metrics of individual process tasks, and to record such metrics in real-time as they occur. In one example embodiment, the database 110 may also contain stored procedures and routines for executing various business rules that govern customization aspects of the method. A further element in the infrastructure components 101 is the Information Technology (IT) Network 112 which comprises all data processing systems (servers and clients), the network infrastructure required to maintain communication between all components, and automated machines for specific tasks. The IT-Network 112 may include all printers, scanners, and document processing equipment required for automatically receiving abstracted title record documents in electronic form. In one example implementation of the present invention, the database 1 10 operates on a network server that is coupled to the IT-Network 112. The IT-Network 112 and database 110 may be coupled to a high level security layer 114, such as encryption and protection from malicious code, commensurate with the requirements of a financial institution, such as a bank or a mortgage lender. In one example, the security layer 114 also manages access to the database 110 and is responsible for authenticating users and providing commensurate access to the IT-Network 112. Further components of the present invention comprise external interfaces 116 which are logical or physical communication ports operative to interface with external entities, such as clients, vendors, field contractors, law firms, courts, financial institutions, government offices, as well as billing and archiving systems. The external interfaces 116 may allow for interfacing to external systems to be performed manually, with the help of data processing software, via Internet websites, or fully automatically, as in one instance, with the use of 3rd party middleware software packages. In one particular example, through messaging and notification via external interfaces 116, the present invention may respond to electronic orders placed for retrieving title records associated with a pending foreclosure. The modules in the present invention for interfacing with external entities, for enabling document transfer or referral of case file and related data are a part of external interfaces 116. These powerful connectivity tools comprise modules for interfacing through client middleware packages, providing information and triggers to billing systems, providing documents and data to archiving systems. In one example embodiment, the present invention supports the commercial middleware packages LenStar™ (from Fair Isaac Corp.), Vendorscape (from First American Default Technologies), and NewTrak™ (from Fidelity National Default Solutions). The infrastructure components 101 thus represent an architecture platform that is operative for enabling users of various embodiments of the present invention to work in a totally paperless manner, or for performing certain automated process steps while other process steps remain in a traditional paper-based methodology.

Referring to FIG. 1B, the core modules 102 of the title record system are illustrated. The core modules 102 comprise several basic methods which may be assembled entirely or in part to form an entire workflow process. The core modules 102 are operative on the collection of infrastructure components 101. In one example, the core modules 102 are client applications implemented in computer program code that interfaces with the database in a client-server mode. The core modules include Case Origination 120, Electronic Analysis 122, Curative Distribution 124, Imaging/Indexing 126, and Administration 128. The modules interact with each other and also via External Interfaces 116 for input and output of title record file documents. Additional modules may be appended to the system or a subset of the core modules may be implemented to form a specific solution for automating a title record workflow process. The core modules may be variously combined in separate embodiments of the present invention in a different order, for example, depending on the desired workflow or degree of automation required. In one example embodiment, the Imaging/Indexing 126 is always performed before Electronic Analysis 122.

Note that as a result of the virtual (i.e., paperless, electronic) nature of the title record case file, whereby access to the case file may be obtained with any data processing system capable of establishing a network connection to the database, all workflow modules and module steps can be performed at physically different locations, independent of each other, without detriment to the efficiency or quality of the workflow processes.

The present invention makes widespread use of a data structure called a worklist, which refers to a list, often represented as a table, of items scheduled for processing by a specific task to which the worklist is associated. In one case, a worklist contains a list of title record case files which represent the items ready for processing by a task coupled to the worklist. A worklist may be organized in an ordered manner, such that the first item of the list is assigned highest priority and must be processed before any other items. The worklist may also be used to distribute workload in a parallel manner to a plurality of individuals in a workgroup who perform the same task simultaneously. The worklist may also be used to distribute work according to a predefined criteria or dependence on any given data field in the database. In one instance, the mechanism by which a worklist is generated and may operate is governed by business rules that are defined for the task to which the worklist is coupled. The worklist may also represent a list of pending items for a particular labor resource, such as a qualified user of the title record processing system. As such, the worklist may be dependent on particular individuals who are registered as authenticated users of the system and may be used to distribute a workload, comprising a plurality of case files, among a workgroup of such individuals.

The items in the worklist may comprise various field descriptors, for defining the attributes of the pending tasks in a worklist. In one example, a worklist may be considered an orthogonal table of records; thus, each item, or record, in the worklist may comprise the same type and number of pre-defined field descriptors, although some of these may be represented with empty, invalid, or unused data entries. In one example of a worklist, the items in the worklist are indexed according to a primary key. In one instance, the primary key for ordering items in a worklist is a unique case file number used for identifying a title record case file.

The act of ‘forwarding’ a particular case file refers to the action of entering or changing elements in a particular worklist for a processing task, with the effect of transferring pendency of the particular case file from the previous originating worklist to a new destination worklist. In one example, an entry for a case file is deleted from the originating worklist and inserted into the destination worklist. In another example, the status of the case file entry is changed to inactive in the originating worklist and in response, changed to active in the destination worklist. These actions have the equivalent effect of transferring the item for processing between the tasks to which the worklists are coupled. The make and break switching logic associated with a case file entry being activated and deactivated, respectively, during transfer between worklists may be performed in any order as required by the process step, including latching and momentary mechanisms.

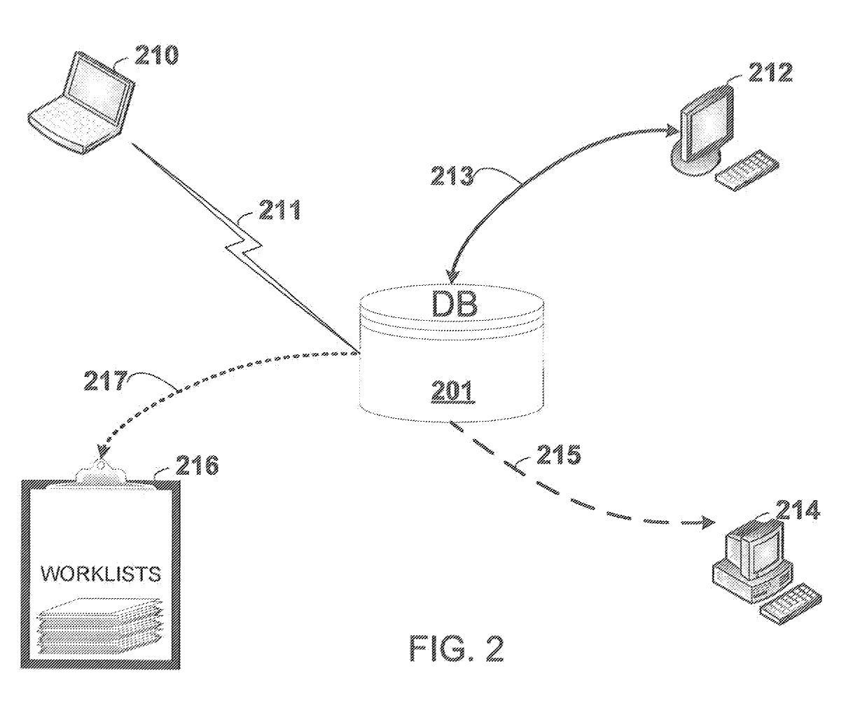

In FIG. 2, an architectural diagram of operative elements that comprise an embodiment of the present invention is illustrated. An implementation of the central database 110 is depicted in FIG. 2 as database 201. The pending worklists in the system are represented by worklists 216, which are linked to the database 201 via interface 217. Interface 217 may represent queries or instructions used for retrieving worklists 216 that may be pending for specific process steps. The interface 217 may be activated by an administrator, for generating worklists, or by internal operators, referred to here as staff, while performing the work of managing their individual worklists. In one example, a staff member may retrieve a pending title record order (represented as a line item in a worklist 216) for processing. In another example, a staff member may mark a completed title record order (represented as a line item in a worklist 216) as processed. The system architecture in FIG. 2 may also comprise external, or field contractors 210, who may access the database via interface 211. In one example, a field contractor 210 is responsible for retrieving all title records in a certain county that does not provide electronic abstracting, and may interface the database 201 via a web interface 211. In one example, the web interface 211 comprises a guided user-interface for performing relevant process steps, such as retrieving an order for abstracting title records, uploading abstracted document images, or answering a questionnaire about the state of the title records in a particular case file. In one example, the web interface 211 provides for the sending of new abstract orders to a field contractor 210 and receipt of the orders within a guided user-interface. In one example, the web interface 211 forces compliance with certain guidelines and entry of relevant information to assure that all documents are provided in a consistent manner and that a high level of reliability and quality of externally abstracted title records is maintained. In one example implementation, the web interface 211 also comprises methods for receiving billing information for work ordered by external contractors 210. In one exemplary instance, images of abstracted title documents are uploaded by interface 211 and automatically linked in database 201 to the particular case file to which they belong. A further element in the system architecture illustrated in FIG. 2 are the internal operators, or staff members, represented by their workstations 212 and their direct network interface 213 to database 201. In one example, network interface 213 is a high-speed LAN. In another instance, network interface 213 may be a remote access or a dedicated WAN connection to database 201. The staff members 212 comprise the labor resources for operating the methods and process steps of the present invention. In one case, staff members 212 are assigned to their own worklists 216 for pending tasks associated with individual title record case files. In another case, staff members 212 comprises a plurality of operators in workgroups who may share worklists, such as for processing a daily workload of title record orders, for spontaneous distribution among themselves. A further element in the system architecture illustrated in FIG. 2 is the output to client systems, represented by element 214, connected to the database 201 via interface 215. Interface 215 may represent an automatic interface, wherein the results of a title record analysis are electronically transmitted, along with access to images of all relevant case documents, to the client 214 issuing the title order. The client workstations 214 may further represent individual entities in the client organization who receive specific tasks, for example as worklist items, involving curative resolution of pending issues in the title record case file. In one example, via interface 215 an embodiment of the present invention may electronically forward notification of curative issues discovered in a title record case file to system operators, paralegal assistants, or attorneys in the client organization, represented by element 214, depending on the curative requirements of the particular issue; the electronic forwarding automatically associates the case file and all original case documents with the notification. In one example, interface 215 generates a hardcopy, i.e., paper printed, version of the case file and notification and description of the curative issues which is sent via postal service to clients 214 who may not have any direct access or involvement with database 201.

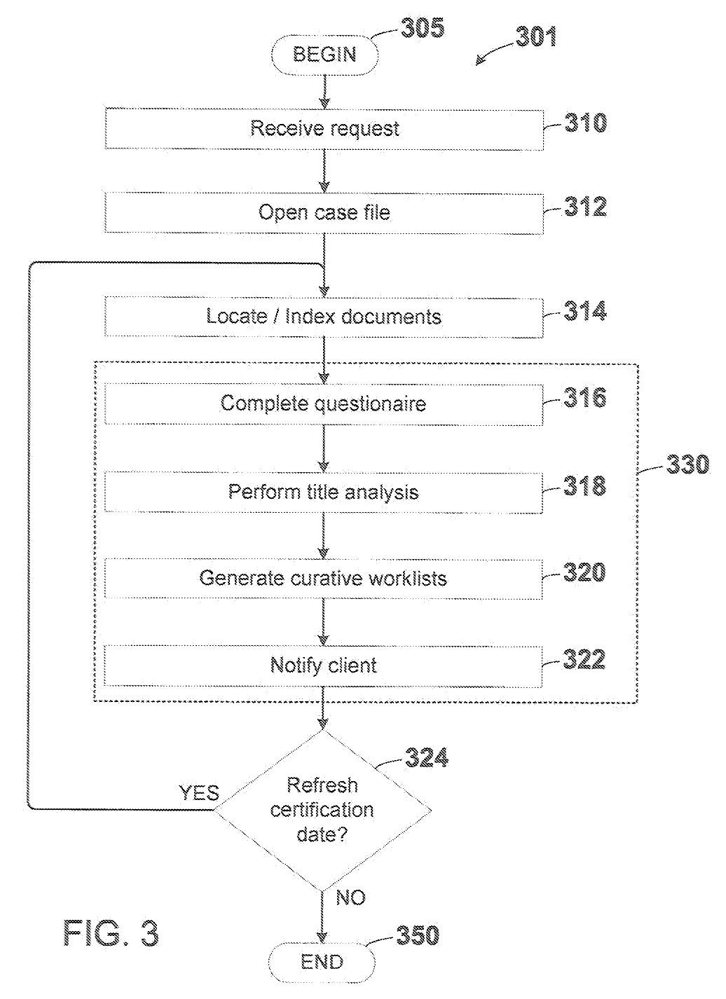

In FIG. 3, a flowchart is illustrated for describing a method 301, applicable to various embodiments of the described invention. The method 301 begins at step 305. In step 310, a request may be received for the processing and analysis of a title record case file. In one instance, the request is a commercial order for legal services and may also be referred to as a referral from a client. In one example of practicing the present invention, the title record analysis is requested 310 by a lender who is initiating a real property foreclosure proceeding against a borrower in default, for determining the condition of the title to the property, in view of a foreclosure sale. The request may be received in step 310 in paper or electronic form. In one example of an electronic referral, client middleware systems, comprising an external interface 116, may be operable for posting a newly issued order for title record analysis. The present invention may be practiced with middleware systems that operate using pushed requests, i.e., actively sending notification of an order, or with pulled requests, i.e., providing an interface, such as a web page, where issued orders are posted and may be retrieved. The next step 312 in method 301 comprises functions and processing steps associated with opening a title record case file. In one instance, step 312 may involve creating entries and indices for the case file, along with related document images and data structures, in the database, as represented by 110. After completion of step 312, the case file has been initialized in the database, such that all subsequent functions, such as worklists, may receive and transmit data records pertaining to the case file. In one example of step 312, this step further comprises method steps for confirming the receipt of the case file from the referring entity, either electronically or by issuing paper-based correspondence. Method 301 may proceed to step 314, which involves the location and indexing of documents related to the title record case file. The documents that may be retrieved in step 314 may include lien documents, deeds of trust, mortgage contracts, warranty deeds, deeds, and any other documents related to an interest in the real property under examination, collectively called title records. Abstracting of title records is a term often used to describe the actions associated with method step 314. However, embodiments of method 301 may perform various process steps during step 314. In one instance, step 314 may be performed by contracting external vendors 210, also referred to as field abstractors, for obtaining title records stored in ledgers in the public archives at county courthouses. The external vendors 210 may return the requested documents as previously described via interface 211. In another instance, step 314 may be performed by obtaining electronic records via a communications network, either from an external vendor or directly from a county government equipped for issuing electronic copies of title records. In one exemplary implementation, the method for completing step 314 may depend upon the county and state in which the real property is located; thus data fields containing county and state information may be used for deciding which method to apply to step 314. Step 314 may also include entry, either automatic or manual, of certain data fields in the electronic case file that are gleaned from the title record documents. Automatic entry may involve scanning title records and performing certain OCR functions, or transmittal of fields from a client referring data processing system. Manual entry of may involve visual inspection of paper documents or electronic document images, and entry into predefined fields, such as loan amount, loan date, or certification date, etc. However step 314 is performed, the result from locating and indexing documents 314 is the storage of electronic images of each and every relevant title record for the current case file, and the indexing of these documents in the database 110 to that case file, such that upon processing the case file from a worklist 216, an operator 212 may view and inspect each original document in electronic form, without having to locate or refer to the paper-based originals for the purpose of performing a title record analysis.

Method 301 then proceeds to a block of steps 330 which represents the core title record analysis functions; these functions involve scrutinizing for, along with identification and reporting of, issues in the title record, such as encumbrances, which may affect an interest in the property. In one embodiment of the present invention (not shown in the drawings), step 314 may be included in the block of steps 330. As shown in FIG. 3, the next step 316 is the completion of a questionnaire regarding the issues in the title. Step 316 may be performed in various stages in separate embodiments of the invention. In one instance, a field contractor 210 may be required to answer certain questions 316 about information contained in a title record that the contractor has been ordered to abstract. A field contractor 210 may be held duly responsible for answers provided in such a questionnaire as a condition for obtaining access to the present invention. In other circumstances for practicing the invention, staff members may be electronically guided through a questionnaire 316 that has been tailored for the particular title record case file. The answers to the questionnaire are electronically recorded and may be used to determine the further course of action (or inaction) on the case file. In one example version of the questionnaire, the individual questions may be very general, for example requiring a simple yes or no answer. The questions may be more detailed in other versions of the questionnaire, for example requiring the input of mandatory data fields when a certain answer identifying a title issue is affirmed. The questionnaire may be customized by the type of property. Additionally, there may be an override mode for changing previous questions presented or editing previously answered questions, for maintenance or management use. The invention may also log each and every action by an authorized user 210, 212 in step 316 in an event log and electronically link this log to the case file. Through use of a standardized, yet customizable, questionnaire 316, the invention provides for maximum flexibility, efficiency, and utility, while assuring a high-degree of quality in performing a title record analysis. After the questionnaire has been completed 316, the detailed title analysis 318 may be performed. Step 318 may involve various, detailed aspects of title analysis. In one situation, the issues identified during the questionnaire 316 may be analyzed and documented in further detail in step 318. In one case, title analysis 318 involves a manual review and analysis of all title records for consistency and accuracy, and identification where problems, inconsistencies, but also encumbrances, may be evident on the title record. The result of the detailed title analysis step 318 may be a generation of title issues whose status may be marked as active, indicating that they must be resolved before the title may be considered cleared for a sale or other kind of transfer of interest. During title analysis 318, the present invention provides for electronic review of all required title documents as digital images. Thus, the efficiency of an operator 212 for performing step 318 is significantly enhanced by the present invention, since no paper-based documents are required as input for method steps in block 330. If no adverse issues are discovered in the title records in step 318, and all potential encumbrances have been cleared, then the title record case file may be certified with the courthouse records date. If issues which require curative action or action by an attorney are discovered in step 318, then each issue is entered in a worklist and distributed electronically for further curative processing in step 320. In one case, curative processing may involve contacting lien holders listed on the title records and verifying the state of the lien on the title. In another case, an attorney may initiate litigation for resolving issues. The method 301 may remain in step 320 as long as issues in the title record remain unresolved; the particular case file may be entered in a worklist of pending matters, and may periodically issue warnings or reminders after a certain period of time has elapsed and the issues remain pending. In another embodiment, step 320 may involve distributing printed versions of the issues, along with the case file documentation, using a postal service back to the referring entity which issued the title record order. Thus the methods of the present invention may be integrated into a fully networked data processing system, or may be practiced for serving business systems in entities relying on traditional paper-based case file processing, or a combination thereof to varying degrees. In step 322, a routine notification to the client (entity ordering the title record) that the requested title search and analysis has been performed, along with the results of the analysis, may be issued in paper or electronic form.

In step 324, method 301 continues to a decision-making step, which may also contain a waiting period, or may be triggered by deadlines or actions in related foreclosure proceedings. The decision in step 324 is made if a recertification of the title (update of the certification date) need be performed. If the answer is YES in step 324, then the block 330 of steps may be repeated. In one case, the block 330 is repeated such that only incremental issues from the time period between the original certification by the system and the recertification are searched and reported. In another example, the entire procedure of block 330 is repeated in full detail. In one example, additional documents may be loaded and indexed with new issues found in the title record upon recertification (not shown in FIG. 3 for clarity). Since the method 301 leads through step 324 for each iteration of the recertification process, only after the answer in step 324 is NO does method 301 terminate and end in step 350. In one embodiment, the title record search may be considered completed at step 350, and a sale or auction of the property being foreclosed may now proceed.

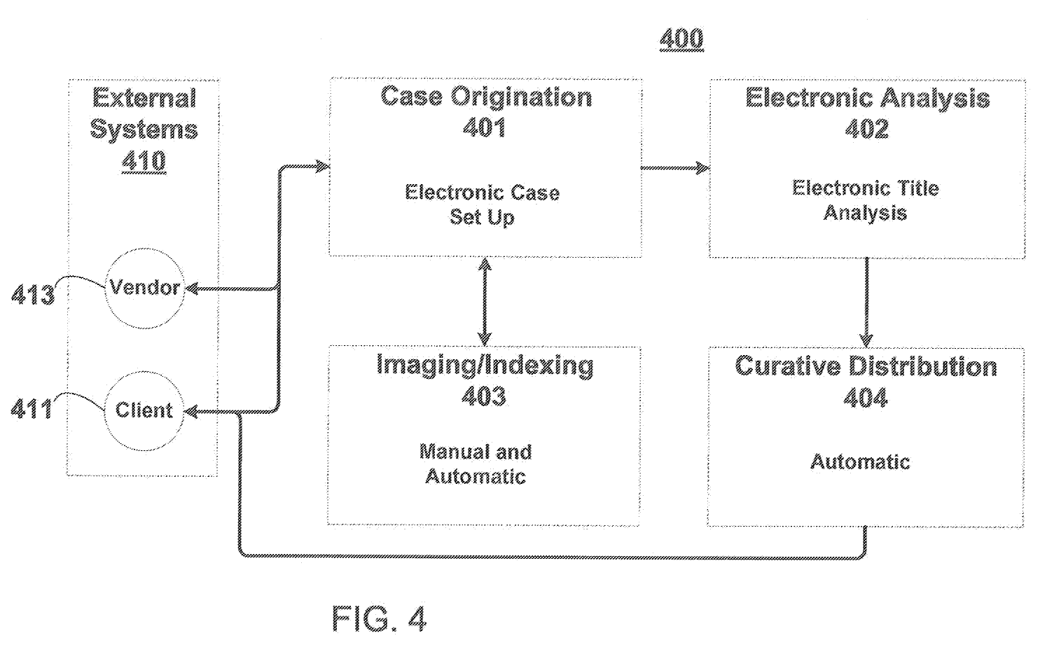

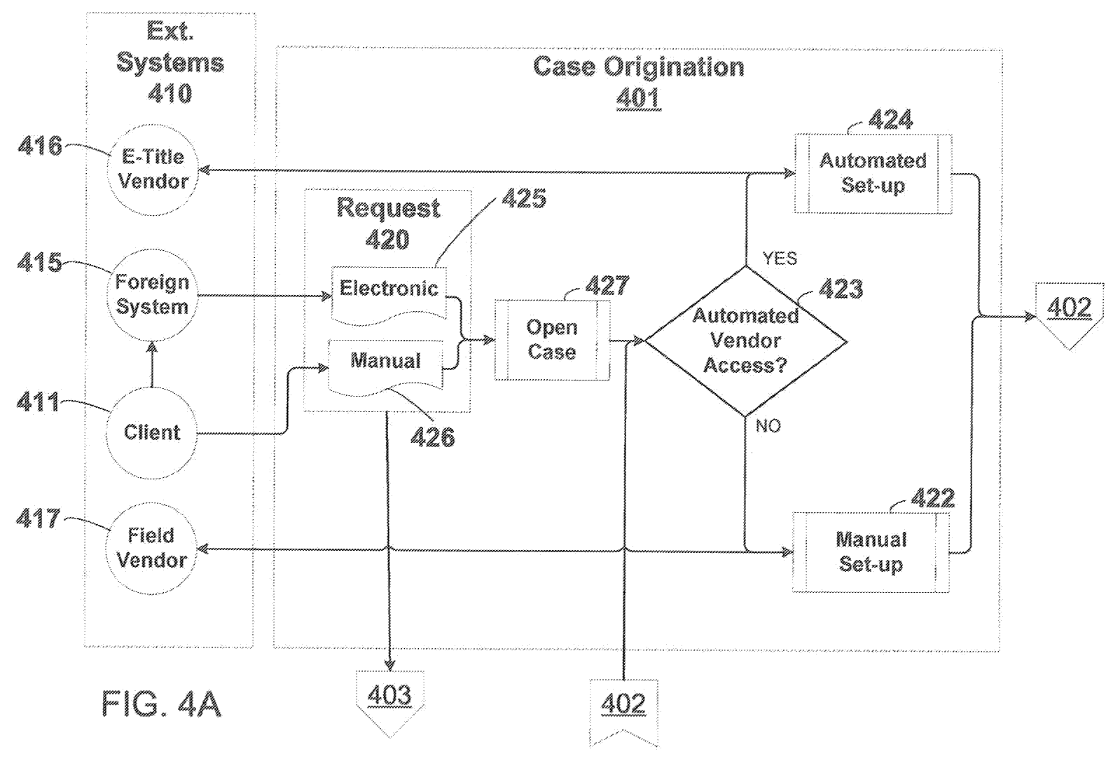

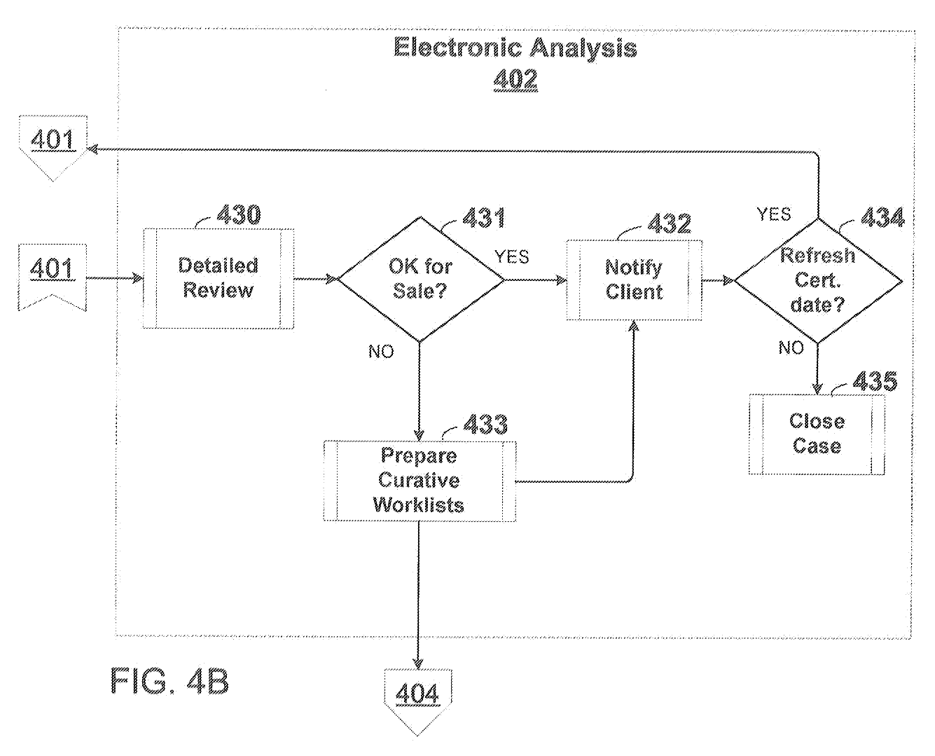

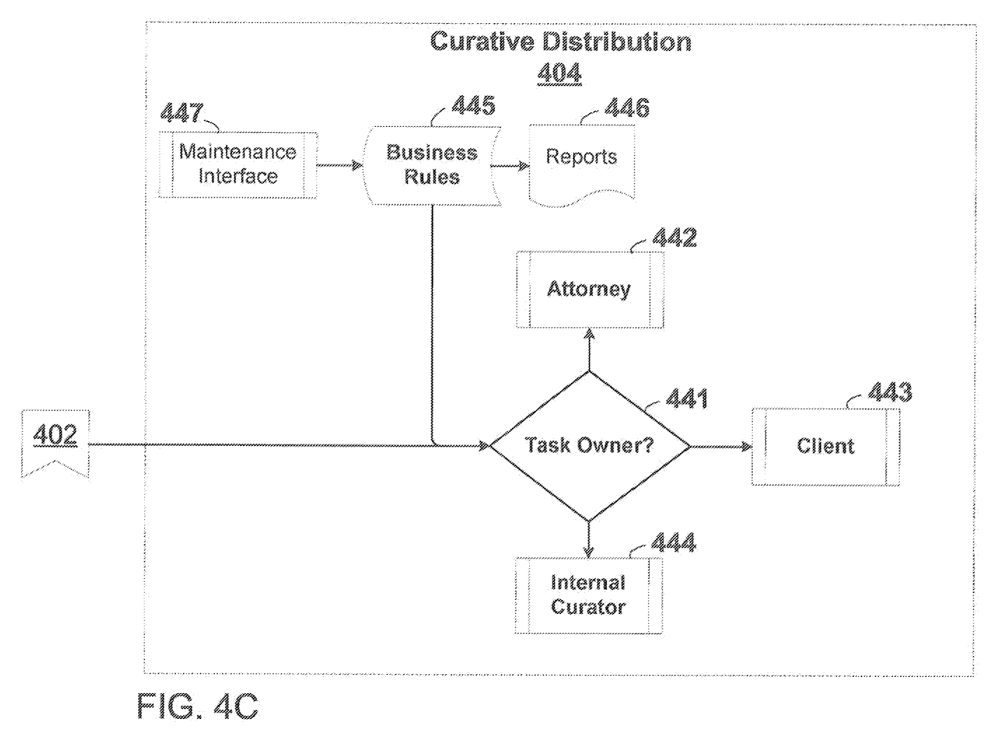

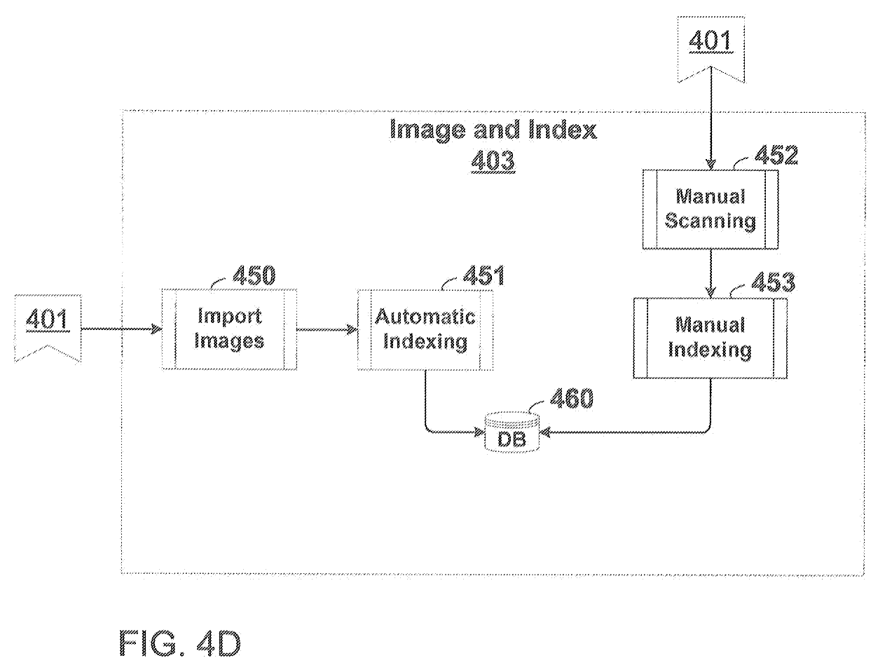

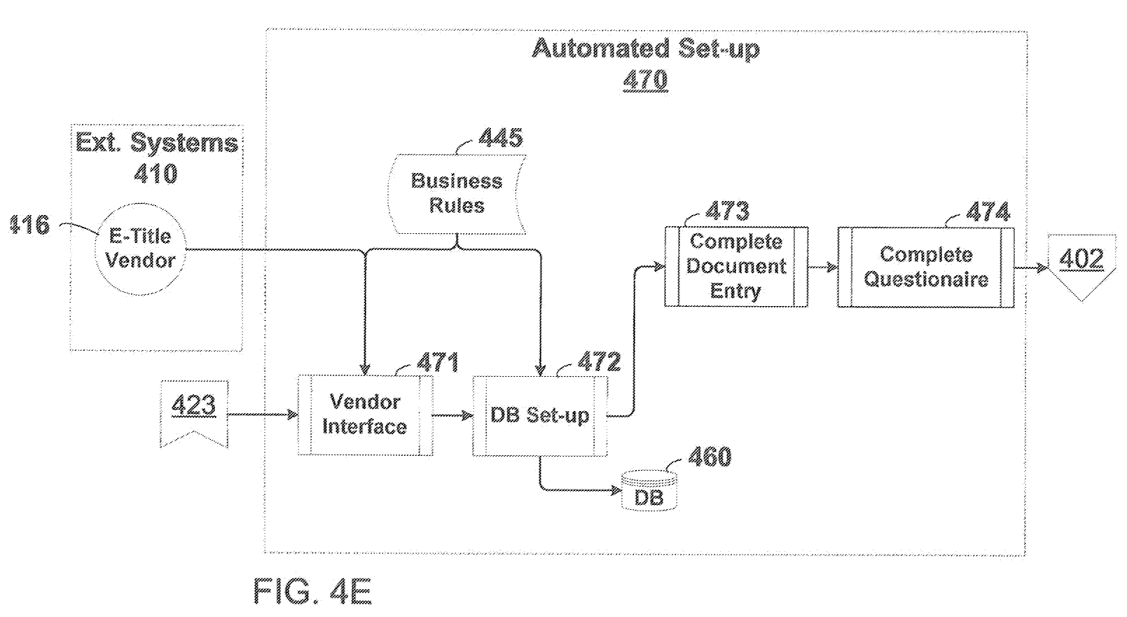

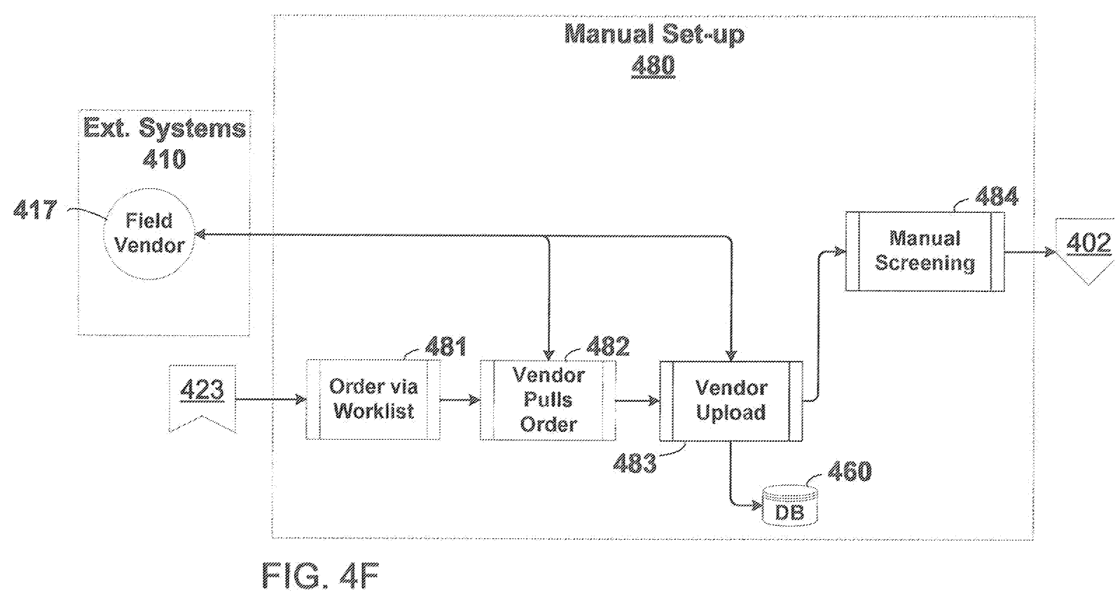

Referring to FIG. 4, the details of an overall process 400 for performing title record search and analysis in one embodiment of the present invention is illustrated. The process 400 comprises numerous modules, components and interfaces including: external systems 410, case origination module 401, electronic analysis module 402, curative distribution module 404, and imaging/indexing module 403. In one example, elements in external systems 410 comprise external entities where title record case files may originate or terminate, including clients 411 and external vendors 413. The case origination module 401 comprises methods which operate for generating new cases and preparing case files for subsequent downstream operations. The electronic analysis module 402 receives the virtual case files by a transfer of the database index on the database from the case origination module 401. In one example, a database index for a title record case file that has been originated in module 401 is transferred to a worklist of pending cases for electronic analysis 402. The electronic analysis module 402 comprises methods for the review of title record documents by a qualified person. In one example, module 402 may comprise a means for electronic signature of documents by the reviewing person. Another core module in the present invention is curative distribution 404, which may receive virtual case files from the electronic analysis module 402. The curative distribution module 404 comprises all workflow processes associated with transferring case files to the internal or external party responsible for the specific title issue. In one example, a curative transfer from module 404 may result in additional abstraction of title record documents. In one example, a curative transfer from module 404 may require legal action by an attorney against an adverse party to the right of interest in the property. In one example, a curative transfer from module 404 may result in litigation initiated by an attorney on behalf of the foreclosing mortgagee. Documents may comprise notice letters and other legal correspondence to external entities. The transfer of title record case files from module 402 to module 404 may occur via copying of case file indices into worklists. In one embodiment, the present invention may provide for collecting a plurality of title record case files in a worklist or batch, which may be released with a single authorization command. At any time during process 400, the present invention permits the removal of any given pending title record case file from the worklist, for example, in response to external events that may forestall foreclosure. The imaging/indexing module 403 in FIG. 4 receives documents and cases from the case origination module 401. The transfer of title record case files to module 401 may occur via copying of case file indices into worklists. Documents in title record case files may also be provided to imaging/indexing 403 from other internal or external entities manually or automatically. Of particular notice in module 403 is the capability for automatically and manually indexing electronic images of documents to the appropriate title record case file, by coupling each document image file to a database index. Manual indexing refers to electronic scanning of documents and indexing into a title record case file by visual inspection of the electronic document and manual entry (or selection) of the case file index. Automatic indexing refers to electronic documents or correspondence which are received and automatically associated with a case file index. In one example, an email message from an external vendor may be automatically linked to a case file based on data gleaned from within the email message. The module 403 also provides the capability of storing electronic images of issued correspondence and any returned postal items in the database, indexed to the virtual case file.

Regarding FIG. 4A, the case origination module 401 is shown in detail with its relationship to external systems 410 in an embodiment of the present invention. The referral of cases to the case origination module 401 may be in electronic or manual form as shown by the request module 420. In case of a manual referral 426 originating from a client 411, any physical documents are forwarded to manual scanning and manual indexing in the imaging/index module 403 (see FIG. 4D). Electronic referrals 425 may be entered by a client 411 into a foreign system 415, which may comprise a middleware for entering the details of the case and automatically forwarding the case file to generate a request 420. Upon electronic receipt of a case request 420, or completion of imaging/indexing of a manual case referral, the case file is originated in the open case function 427. The open case function 427 creates a data record for the title record case in the central database and prepares the electronic case file for all further processing. The open case function 427 may comprise all process steps required for creating data tables, linking relevant case information (such as client and billing information), and issuing notices or confirmation via necessary interfaces to transactional parties related to the case file. After the case has been opened in step 427, the case file also is equipped with tracking and logging records, in one case via indexed database tables, which provide time stamped information on what actions were performed on the case file and by whom. Next, in step 423, a determination is made if a vendor is able to supply the required title records for the title record case file via an automated interface, such as an electronic service offered by an E-Title Vendor 416. If yes, then the case file may be processed via automated set-up process step 424. Otherwise the case file is processed via manual set-up in process step 422, which relies upon a field vendor 417 for retrieval of the title records. In one exemplary embodiment of the present invention, the decision in step 423 is based upon the county in which the real property is located, which determines if an automated vendor 416 is available, and which vendor (automated 416 or field 417) services that particular county. Other decision logic in step 423 may be implemented via customizable business rules in other implementations of the invention.

One example of an implementation of an automated set-up 424 is provided in FIG. 4E. In FIG. 4E, an automated set-up process 470 begins with a title record case file initiated query of a vendor interface in step 471, after a determination in step 423 that the vendor 416 provides electronic title (E-Title) service for the case file. The vendor systems are represented within external systems 410, whereby an authorized communications interface, such as an authenticated network connection, is provided. In one instance the interface to an E-Title Vendor 416 may be realized via a web-browser over the Internet using a username and a password to provide security clearance. In step 471, depending on the business rules 445 that are applicable and govern the particular transaction, the vendor 416 is queried for the title records and documents required for processing the case file. In one case, this may involve issuing a request for certain documents, and opening a request task with the status of pending, and waiting until such documents are delivered by the vendor 416, and then closing out the pending request task. The vendor interface 471 may be implemented with certain steps in manual or manual override mode, such that a pending request task requires a user to manually acknowledge receipt of a queried document. The vendor interface 471 may also be implemented with vendor-specific middleware modules, such that the function is fully automated. After the documents have been received, they are entered and indexed into the database 460 in the database set-up step 472. In step 473, the document entry is completed, which provides for a check and a review of the case file, to make sure that the documents are readable and are the correct documents pertinent to the case file. In step 474, the system provides a customized questionnaire, based on the information in the case file (from the business rules and from the client referral) which is a point-by-point list of items that must be verified and acknowledged in a specific order. The generation and completion of the customized questionnaire in step 474 provides for a high-level of quality in the overall title analysis, while eliminating unnecessary steps that may not be pertinent to a given case. The questionnaire in step 474 also provides for a logical consistency of the analysis results. For example, in one case, questionnaire 474 may have logical branches that generate or eliminate questions based on previous answers to previous questions. After completion of step 474, the process 400 continues to Electronic Analysis 402 shown in FIG. 4B.

One example of an implementation of an manual set-up 422 is provided in FIG. 4F. In FIG. 4F, a manual set-up process 480 begins with a placement of an order 481 to a field vendor 417 (also referred to as a vendor, contractor, or field abstractor), after a determination in step 423 that the vendor 417 provides abstracting service for the case file. The external field vendors are represented within external systems 410, and use a public network, such as the Internet, to access pending orders and upload abstracted documents. In one instance the interface to field vendor 417 may be realized via a web-browser over the Internet using a username and a password to provide security clearance. In step 481, an order is placed with the field vendor for certain documents related to the title records of a pending case file. In one case, this may involve issuing a request for certain documents, and opening a request task with the status of pending, and waiting until such documents are delivered by the vendor 417, and then closing out the pending request task. In step 482, the field vendor 417 retrieves the order and performs the work of locating the documents and generating the scanned images of the documents. In one instance, the field vendor 417 must go to the county courthouse and manually retrieves documents and scans them into digital form. After the documents have been prepared for transmittal, in step 483 the field vendor 417 uploads the documents into the system. In one embodiment of the present invention, the upload step 483 may be performed using the same web-browser interface as was used for step 482. In step 483, the documents are uploaded and indexed to the title record case file in the database 460 for which the order was issued. The field vendor 417 maintains responsibility for accuracy and completeness of the title records uploaded in step 483. In one instance, step 483 is accompanied by a checklist of items that the field vendor 417 is required to confirm, which may include a preliminary analysis and cross-check of the title records depending on the issues in the particular case. Thus after step 483, the results of the checklist, along with all original documents, may serve to guide the further analysis and processing of the case file. In step 484, after document entry is completed, another manual screening and review is performed on the case file, to make sure that the documents are readable and are the correct documents pertinent to the case file. After completion of step 484, the process 400 continues to Electronic Analysis 402 shown in FIG. 4B.

After the Case Origination module 401 has completed, the documentation and pre-analysis that has been performed serves to assure that all information is valid, consistent, and accurate. In one example of a foreclosure quality control step, the name of the mortgagor and the address of the property have been checked between title documents and loan documents. One example of a result of control steps is that a request for clarification or further documents may be made if additional information is required in the case. At the output stage, the module 401 may also contain a case origination queue (not shown in the drawings), which is capable of buffering case files until they are complete, or simply holding them back over other case files which have been assigned higher priority. The priority of title record case files may be raised in the case origination queue, as in other modules of the present invention, to facilitate expedited processing of urgent case files, or those that become urgent at a certain point in time while they are under processing, or as defined by business rules governing case file priority. The result of raising the priority of a case file in the case origination module 401 includes advancing the case file in the output portion of the case origination queue. Cases also return from electronic analysis 402 to case origination 401 (not shown) upon error, for further processing, or for other reasons why the case file needs further attention by set up modules 424, 422 in the case origination module 401. The present invention provides the means to analyze and continuously improve the processing of case files, such that the sources of error may be continually researched and eliminated.

Referring to FIG. 4B, the electronic analysis module 402 contains the elements for analyzing the title record case file by a qualified user of system 400 in an embodiment of the present invention. From the case origination module 401 the cases are entered into a worklist showing which cases are ready for detailed review 430. The worklist ready for review 430 is linked to stored data comprising images, links and comments. The stored data is individually linked (and accessible to the user) for title record case files in the incoming work list for step 330. Depending on the particulars of the title record case, a determination is made in step 431 as a result of the review and analysis performed in step 430, if the real property to which the case file pertains is free from encumbrances and may be sold. In one instance, the results of the title analysis may be used for underwriting a title insurance policy in the case of a foreclosure sale of the real property. The determination in step 431 represents a central aspect of the present invention: the issue of the certification date of the title analysis in case the real property is deemed ready for sale. In step 432, a notification of the client is performed after the title records have been cleared for sale in step 431. In other embodiments of the present invention, client notification steps may be introduced at various locations in process 400, depending on legal requirements and client preferences. In step 434 a determination is made if the certification date of the title records must be performed again at a later date to facilitate a sale. For example, certain government regulations may require that a title record be performed within a certain period. In step 434, a delay period or wait action until an external event occurs may be performed, either before or after the determination for refreshing the certification date of the title is performed. In case a refresh of the certification date must be performed, the process flow may return in a loop to step 423 and repeat. If no changes have been made to the title records since the first time the setup 424, 422 and review 430 steps were performed, the certification date can be refreshed. If however, new issues, such as additional liens, have been filed on the title records since the original certification date, the new certification date will reflect such changes to the status of the title records. If in step 434, no further certification refresh is required, then in step 435 the case may be closed out. Close out steps in 435 may include issuing of notices to clients and third-parties of the status of the title records, generation of billing statements and invoices for the title analysis, and close-out of all pending worklists and open tasks in the system for the case file.

If the title records exhibit encumbrances that stand in the way of a sale, as determined in step 431, then the present invention provides extensive means for curative action on the title records. The next step is preparing the curative worklists 433, based on the issues that were discovered with the title records in step 430. The title record case file is certified with the issues and encumbrances documented as of the certification date. After step 430, a notification of the referring client that encumbrances to a sale are present, and what those encumbrances represent, may also be performed in step 432. Note that step 434 may hold the case file until a notification is received that all curative worklists generated in step 433 have been resolved (see FIG. 4C, module 404), so that a refresh of the certification date will report a title clear for sale. After the curative worklists have been prepared in step 433, the process flow continues to FIG. 4C.

Referring to FIG. 4C, the curative distribution module 404 is illustrated comprising all elements for distributing the legal work for clearing the title of encumbrances among those parties who are qualified and responsible for the work, in an embodiment of the present invention. The curative distribution module 404 relies on business rules 445 for determining various courses of action for case files. The maintenance interface 447 is used to update the business rules, to review them, and to add additional business rules 445 as is required for normal maintenance of the system. The business rules 445 determine the course of action taken depending on the issues in the case file and may also contain client-specific preferences for conmunicating and billing related to title record analysis services. The curative distribution module 404 also permits the generation of internal reports 446, comprising statistical or performance measures about the functioning of the entire system 400. The curative distribution module 404 performs an analysis of the worklists generated in step 433 to determine in step 441 the parties responsible for the curative tasks associated with a title record case file. The workload is then distributed among the qualified and responsible parties. In step 442, litigation or other legal action required for curative resolution of title issues may be performed by an attorney in step 442. Examples of issues requiring attention of an attorney in step 442 are lawsuits, dispute resolution, or family law issues (i.e., divorce or probate), that relate to the real property or to persons who have interest in the real property. Another possibility for distributing curative issues in step 441 is that the referring client in step 443 may receive the title record case file for all further processing internally. In step 443, the case file may be transferred in physical form i.e., paper hardcopy printouts, or in electronic form, i.e., with a corresponding interface and infrastructure, back to the client, along with the results of the title analysis and all documentation. Another curative option is that a curative specialist within the organization providing the title analysis service, in step 444, resolves the curative issues. In each case, steps 442, 443, 444, the resolution or close-out of the case is monitored and reported, and may trigger action on another portion of the process that is waiting for resolution of all open issues in the title record case file. In one instance, after all curative issues are resolved, the certification date of the title is refreshed and a new report is generated with verification that the title is clear for sale. Other curative options (not shown) may be accessed from step 441 allowing curative tasks to be distributed, monitored, and closed out. In one instance, after the title record has been closed out and all curative issues resolved, a foreclosure sale can commence and the real property may be conveyed to a new grantee.

Referring to FIG. 4D, the image and index module 403 is shown providing the means for generating digital images of documents and linking the resulting image files electronically to individual case files, in an embodiment of the present invention. The case file indexing of all digitally imaged documents is a key feature of the invention that enhances efficiency and streamlines dependent methods in the system. The advantages include a reduction in the amount of queries required to retrieve a document associated with a particular case file In process 403, documents in paper form are manually imported into the system by scanning in step 452. After manual scanning 452, each individual scanned image is manually indexed in 453 into a title record case file in the database 460. In one example embodiment, the manual indexing is performed by viewing electronic images of the documents and then assigning, selecting, or verifying an appropriate case file index. The import of imaged documents is performed in step 450, whereby electronic images of documents may be received via email or web-browser interface, or may be delivered on a data storage medium. Using data fields supplied with the images, automatic indexing of the electronic documents is performed in step 451, resulting in the indexing of the title record case file in the database 460.

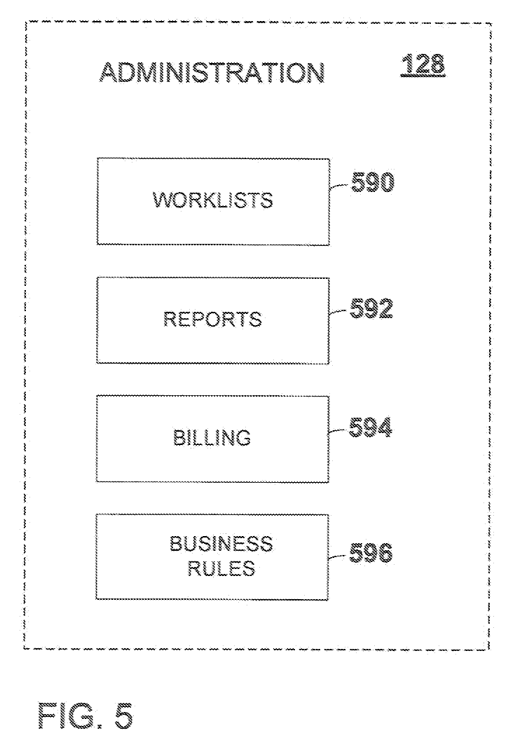

Referring to FIG. 5, methods of an embodiment of the present invention relating to Administration 128 of title record case files are illustrated. These methods comprise data elements and operations for maintaining (i.e., creation, editing, appending, deleting, etc.) the data elements. The data elements may comprise tables and indexes in the database, but may also comprise process control elements, such as triggers, notifications, and status updates. One administrative method is the Worklists 590, which comprises the list of pending tasks for a given function, and corresponds to the worklists mentioned with respect to the functional modules of the present invention. A farther administrative method is the Reports 592, which provides statistical and usage information about data elements, case files, users, and modules. Reports may be defined and customized to provide managers and administrators with views such as tables or graphical charts for quantitative and qualitative performance measures or other indicators related to process 400. The Billing method 594 comprises information on individual case files and the services provided for a given order from a given client. The Billing method 594 is responsible for maintaining clients and case file accounts up-to-date in real time and providing consolidated financial data to interface with related financial systems. The Business Rules 596, of which an example embodiment is element 445, comprise methods for determining rules and procedures that are customizable in terms of client preferences or revised process flow.

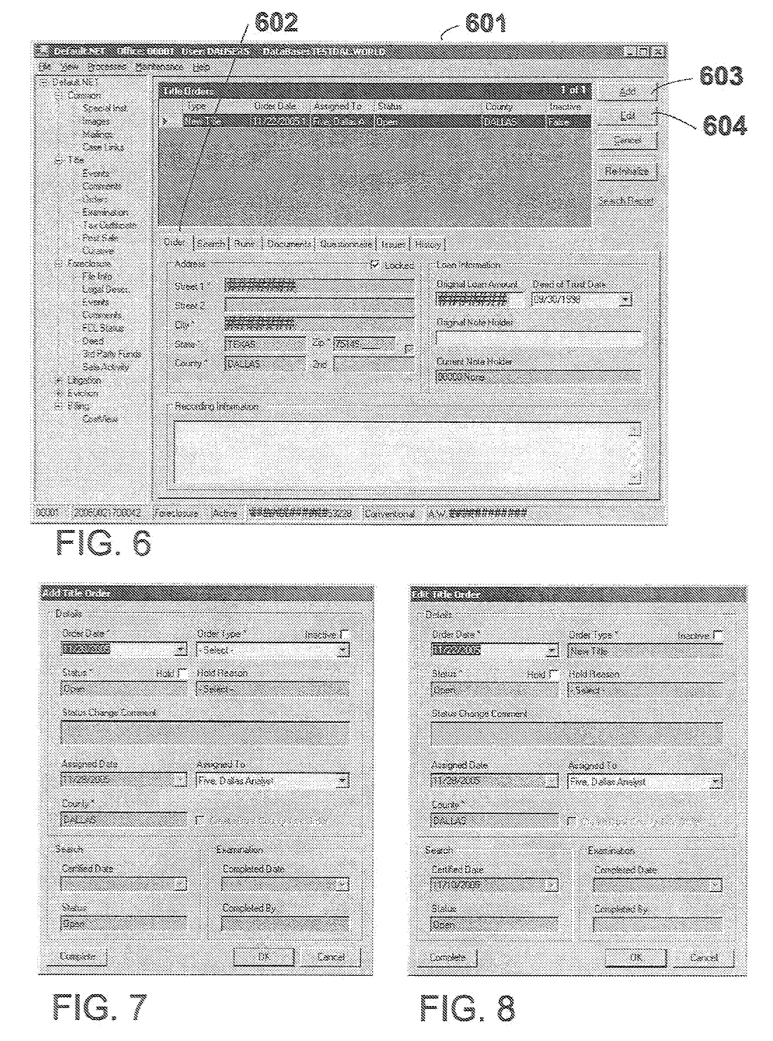

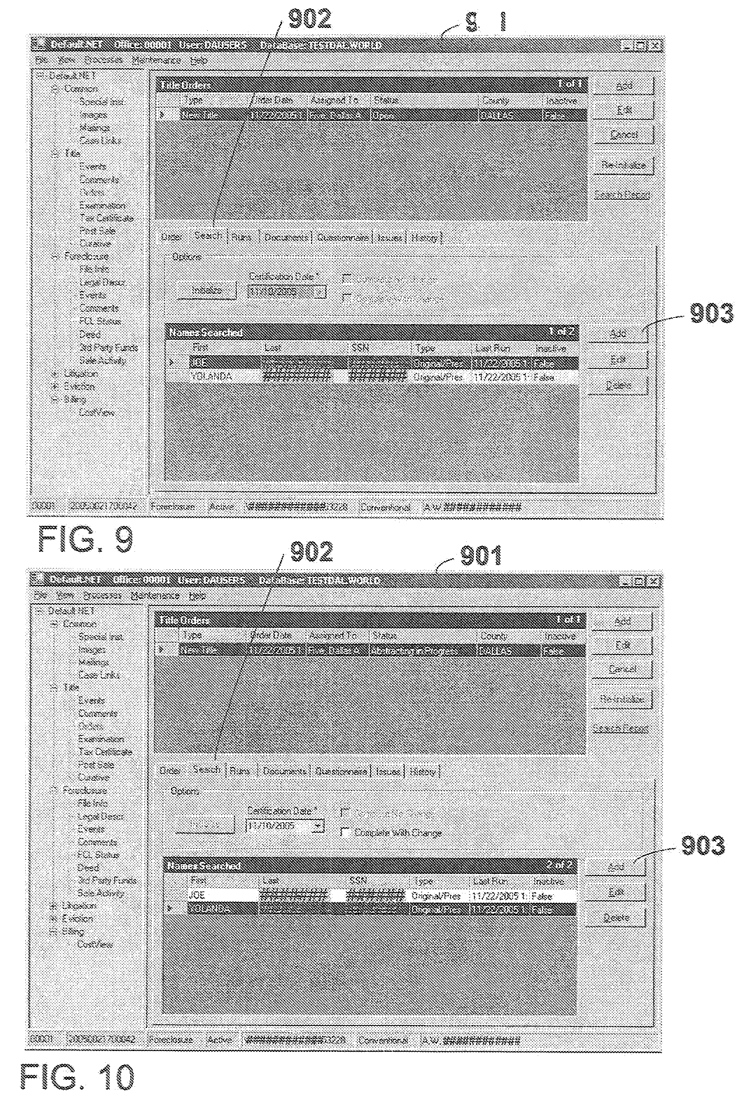

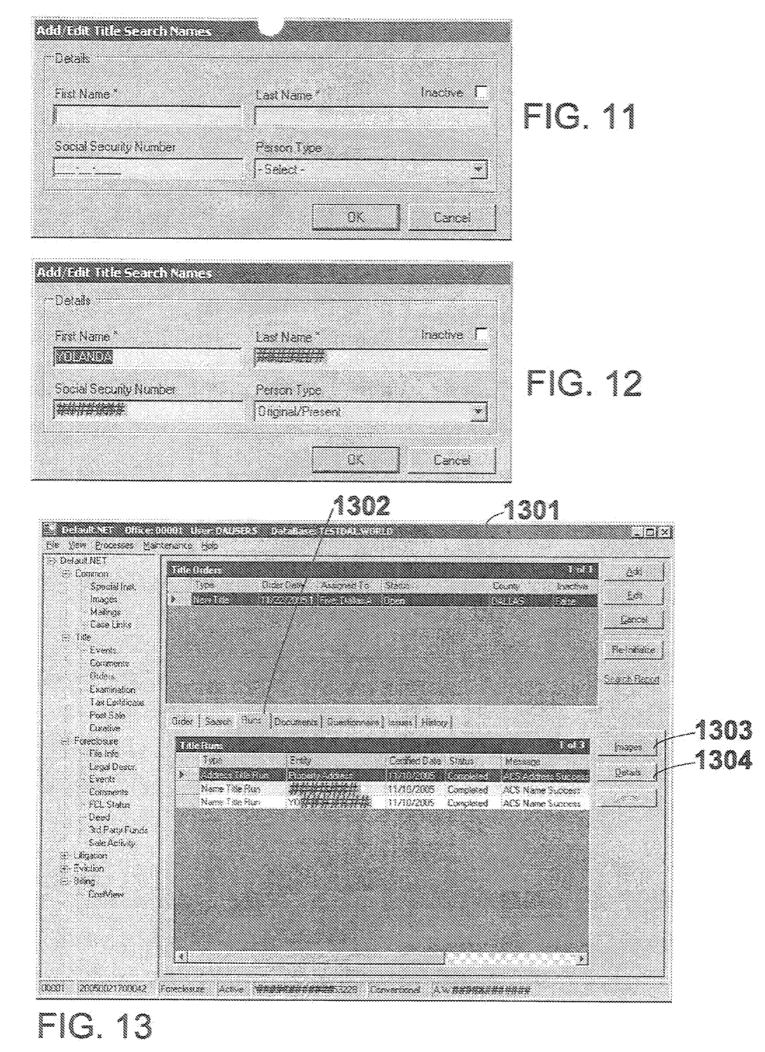

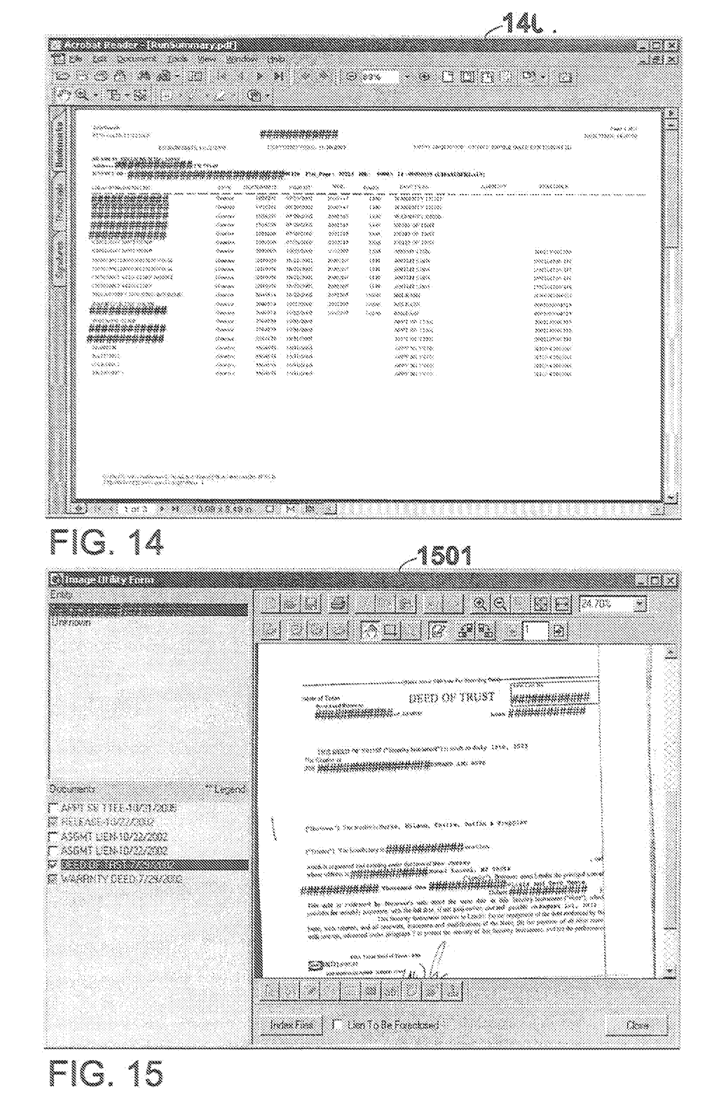

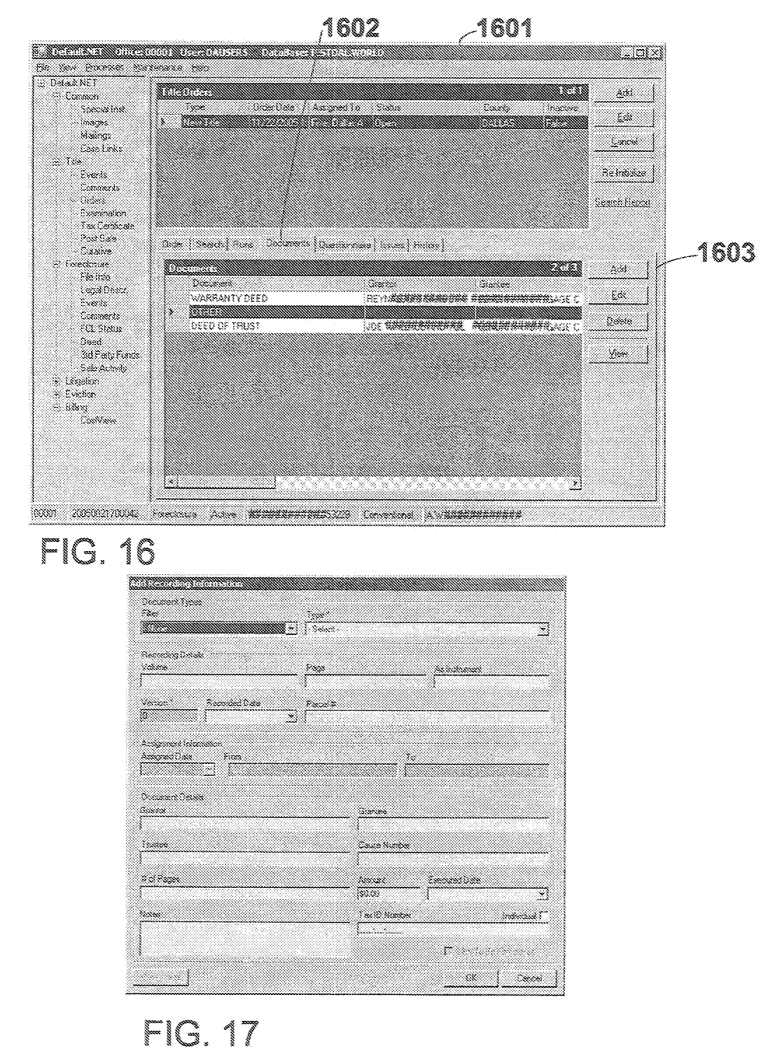

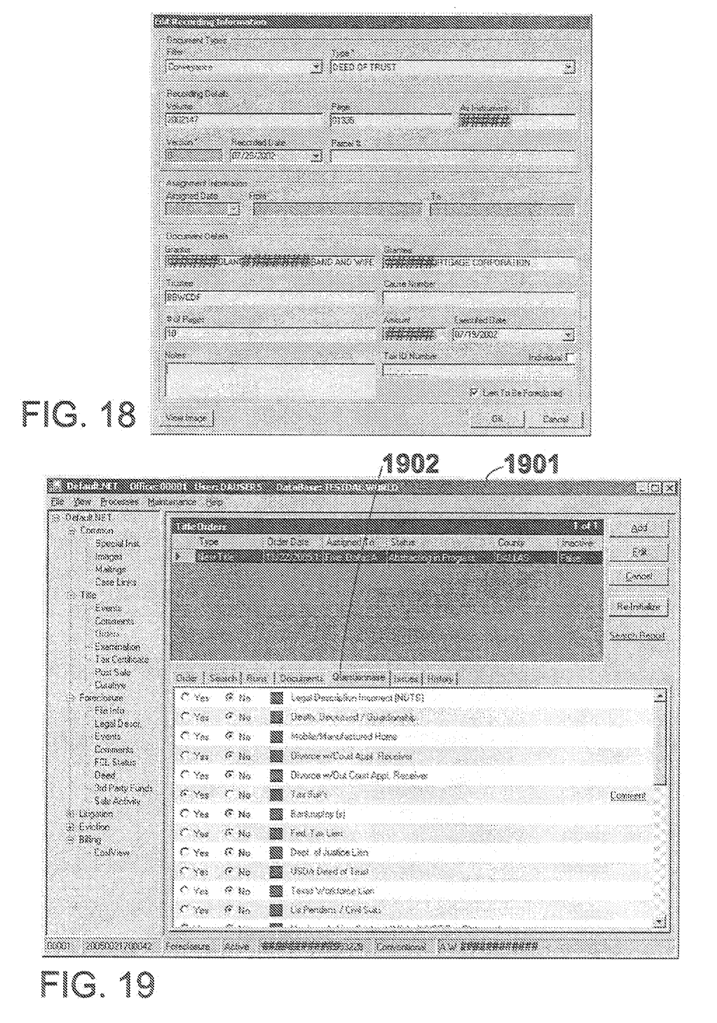

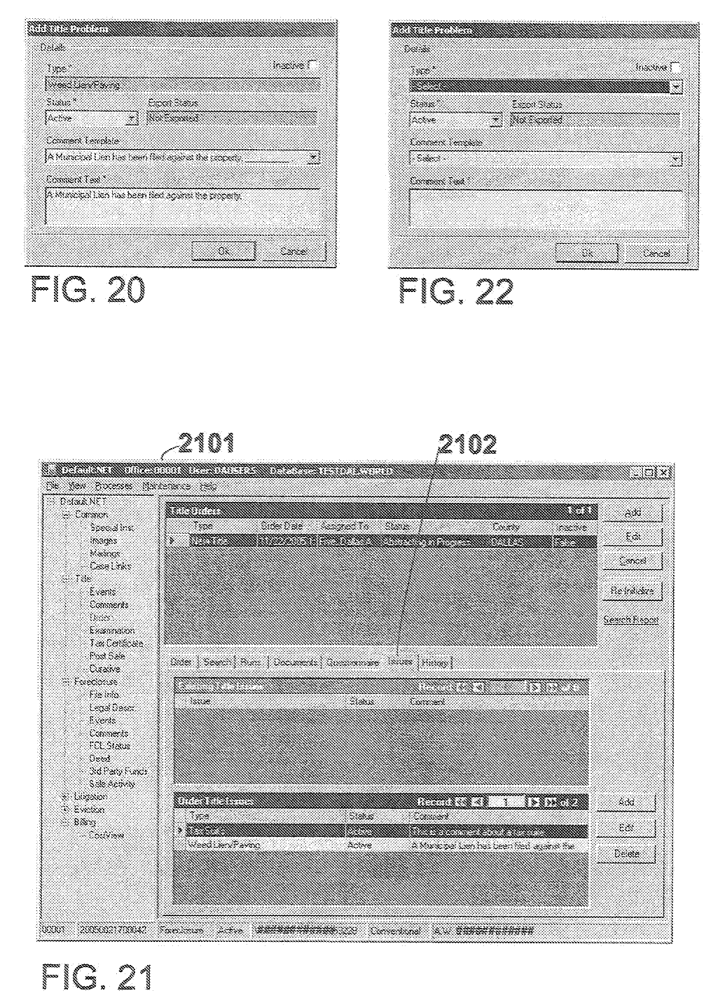

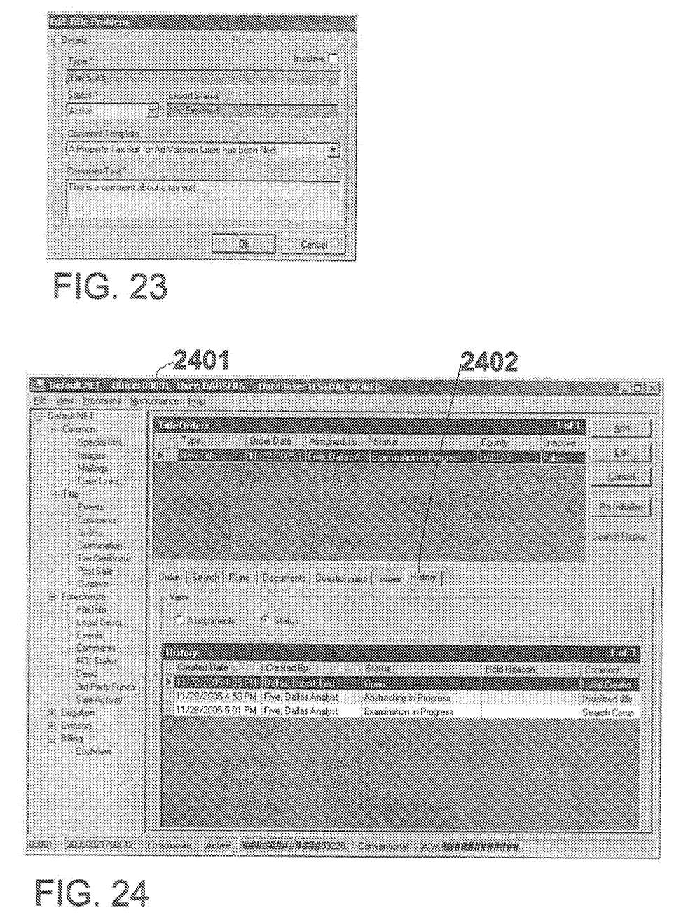

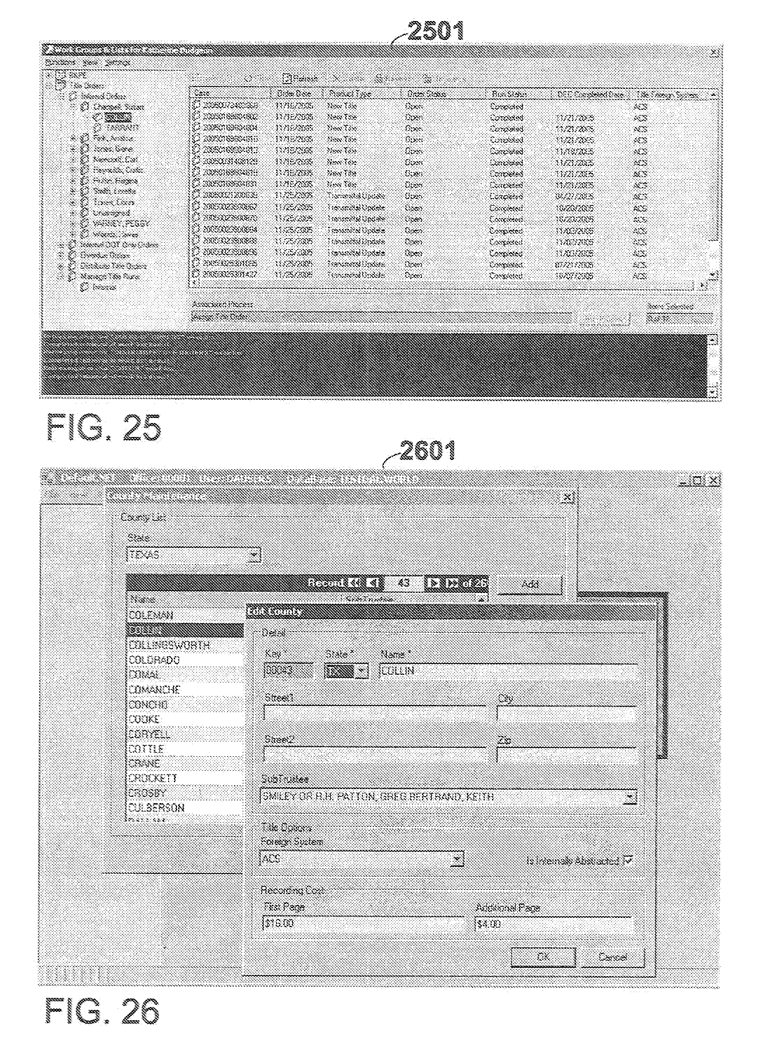

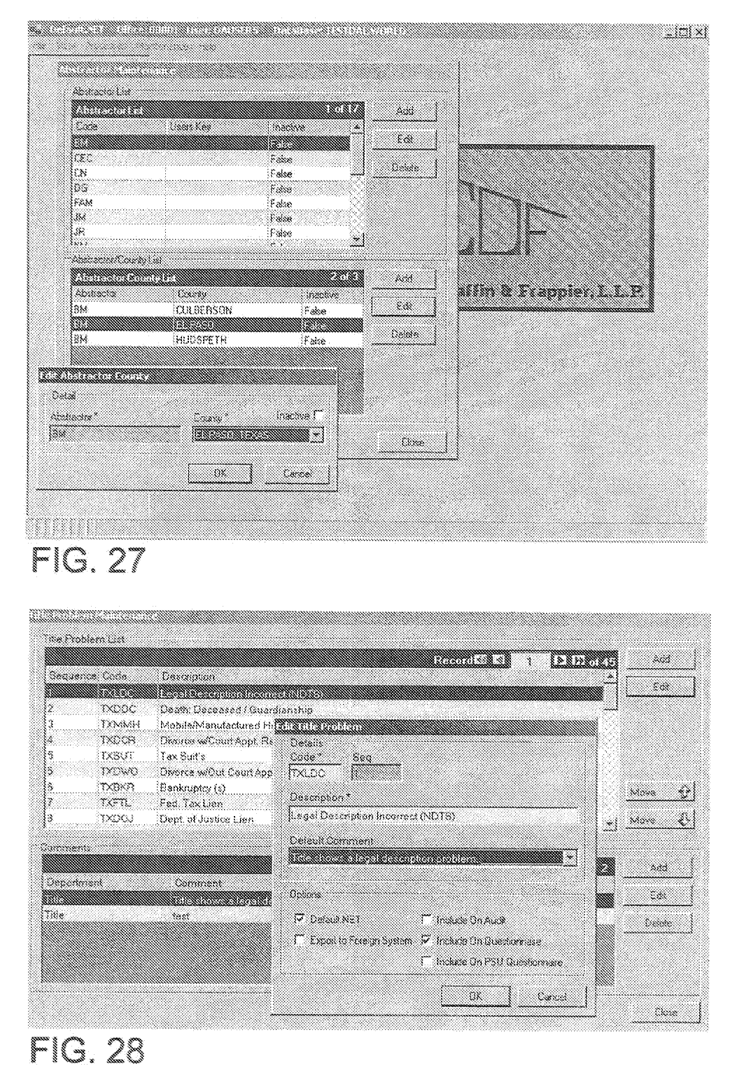

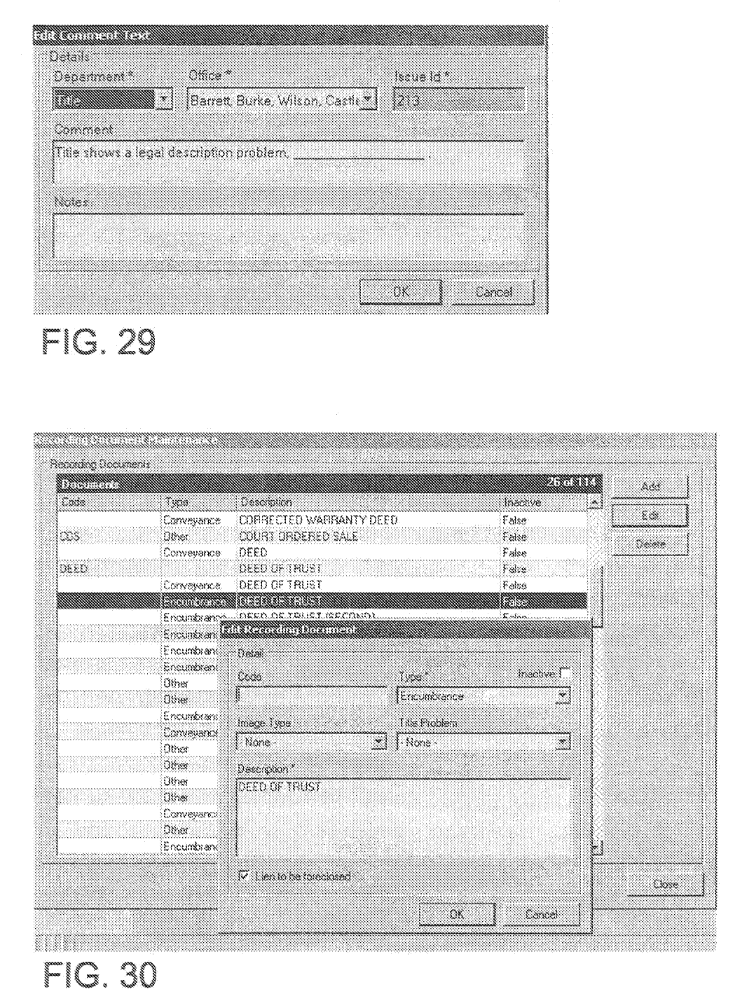

FIGS. 6-30 illustrate examples of user interface panels for a foreclosure title analysis process in an embodiment of the present invention. FIG. 6 shows how title orders are managed in the “Order” tab 602 of a main panel 601. By pressing the “Add” function 603 in FIG. 6, the panel shown in FIG. 7 appears for adding a new title order. In FIG. 8, the data in an existing (i.e., previously created) title order may be edited after selecting the “Edit” function 604 in FIG. 6. In FIG. 9, the “Search” tab 902 of a main panel 901 is illustrated, wherein names of mortgagors may be entered for searching. In FIG. 10, the panel from FIG. 9 is shown as second name is selected and after initialization of the abstracting process for the names entered. In FIGS. 11 and 12, panels for adding or editing names from the appropriate buttons 903 in FIGS. 9 and 10 are illustrated. In FIG. 13, the “Runs” tab 1302 is illustrated of a main panel 1301. The “Runs” tab shows which searches were performed and the status of each search. For example, a search for title records may be performed based on a property address or based on the list of names entered in the “Search” tab 902. In FIG. 14, the detailed search results 1401 are summarized as returned by an electronic search vendor, as a result of selecting the “Details” function 1304 from FIG. 13. In FIG. 15, a utility 1501 for viewing electronic images of title record documents is illustrated, as a result of selecting the “Images” function 1303 in FIG. 13. The utility 1501 shows the documents linked by index to the particular case file related to the current title order. In FIG. 16, the “Documents” tab 1602 of a main panel 1601 is illustrated. In FIGS. 17 and 18, panels for adding or editing recording information from the appropriate buttons 1603 in FIG. 16 are illustrated. In FIG. 19, the “Questionnaire” tab 1902 of a main panel 1901 is illustrated. The questionnaire is a structured list of issues that must be addressed while performing the title analysis. If any issues that may lead to an encumbrance are identified in the questionnaire, further processing of the case file may be directed accordingly to address the potential encumbrance. In FIG. 20, a panel for adding an item to a questionnaire is illustrated. In FIG. 21, the “Issues” tab 2102 of a main panel 2101 is illustrated, wherein the pending issues for the title record case file are summarized, whereby the issue is of a nature that would interfere with a sale of the real property. In FIG. 22, a panel for adding a pending issue or a comment about a title problem to the case file is illustrated. In FIG. 23, a panel for editing a pending issue or a comment about a title problem to the case file is illustrated. In FIG. 24, the “History” tab 2402 of a main panel 2401 is illustrated. The “History” display 2402 is a time stamped log of all the activity on the title record case file and provides linked status information on each pending task. In FIG. 25, a worklist display panel is illustrated. The worklist comprises individual title cases that may be assigned to individual users, and may be classified according to the county in which the real property in the title record case file is located. In FIG. 26, a maintenance panel for administering the settings for a particular county is illustrated. In one embodiment of the present invention, the decision 423 (or selection) may be determined by the county of the real property. In maintenance panel 2601, the information and options for the particular county may be entered and managed. The panel 2601 serves as a data input for all automatic decisions and business rules pertaining to the county. In FIG. 27, a maintenance panel for defining individual field abstractors and assigning them to specific counties is illustrated. In FIG. 28, a list of abbreviations and codes for specific title problems and issues is illustrates, whereby the list serves as a reference table for looking up the text and legal description of the problem. In FIG. 29, a panel for editing the comments in the list shown in FIG. 28 is illustrated. In FIG. 30, a maintenance panel for defining the common types of recording documents associated with a title record case file are defined.

Although the present invention and its advantages have been described in detail, it should be understood that various changes, substitutions and alterations can be made herein without departing from the spirit and scope of the invention as defined by the appended claims.

What is claimed is:

1. A method for processing and analyzing a real estate title record case file utilizing a database configured to store data related to the title record case file, a computer network coupled to the database, the computer network having one or more processors, at least one input device and one output device, a memory, a scanning and imaging device, the computer network coupled to one or more external systems via a communication network, the method comprising the steps of:
receiving, via the communication network, a request from a referring entity for processing and analyzing the title record case file and receiving documents related to the title record case file;
processing the title record case file, wherein the processing includes creating entries and indices for the case file, generating electronic images of the documents and storing the images of the documents in the database;
indexing the documents in a database, wherein upon indexing an operator may review the documents in electronic form for performing the analysis;
answering one or more predetermined questions related to issues in the title record case file;
analyzing the documents by electronically reviewing the documents and analyzing the issues identified in the answers to the questions;
generating a worklist of issues requiring curative action, the worklist of issues based on the answers to the questions, and electronically distributing the worklist for curative action;
certifying the title record case file if no adverse issues are identified in the analysis and encumbrances are cleared;
attaching an electronic signature to the case file;
electronically sending the results of the analysis to the referring entity; and
repeating one or more of the foregoing steps if re-certification is required.

2. The method of claim 1, wherein the re-certification is required for an updated certification.

3. The method of claim 1 further comprising automatically sending printed copies of any adverse issues along with related documentation to the referring entity.

4. The method of claim 1, wherein the curative action comprises contacting lien holders listed on the title record and verifying the state of lien on the title.

5. The method of claim 1, wherein the curative action comprises initiating litigation by an attorney.

6. The method of claim 1, wherein the documents include lien documents, deeds of trust, and warranty deeds.

7. The method of claim 1, wherein the documents are received electronically from an external vendor or a government entity via a communications network.

8. The method of claim 1, wherein the step of indexing includes scanning title records.

9. The method of claim 1, wherein the step of indexing includes transmittal of fields from a referring data processing system to a database.

10. The method of claim 1 further comprising the step of electronically transmitting a receipt of the case file from the referring entity.

11. The method of claim 1, wherein the request is a commercial order for legal services.

12. The method of claim 1, wherein the request is made by a lender initiating a real property foreclosure against a borrower in default, for determining the condition of the title to the real property.

13. A system for processing and analyzing a real estate title record case file, the system having a database configured to store data related to the title record case file, a computer network coupled to the database, the computer network having one or more processors, at least one input device, at least one output device, a memory, a scanning and imaging device, the computer network coupled to one or more external systems via a communication network, the computer network, the system further comprising:
a case origination module configured to receive the title record case file from external systems originating the case file and configured to prepare the case file for downstream operations;
an electronic analysis module configured to receive the prepared title record case file from the case origination module and to allow a review of the case file by a reviewer, the electronic analysis module providing an electronic signature of the reviewer;
a curative distribution module configured to receive the prepared title record case file from the case origination module and to transfer the case file to one or more internal or external parties for curing title related issues; and
an imaging and indexing module configured to receive the prepared title record case file from the case origination module and to index electronic images of the case file by coupling document images to a database index.

14. The system of claim 13, wherein the electronic analysis module receives the case file by a transfer of the database index from the case origination module.

15. The system of claim 14, further comprising transferring the database index to a worklist of pending cases.

16. The system of claim 13, wherein the external systems comprise clients and external vendors that originate the title record case file.

17. The system of claim 13, wherein a curative transfer from the curative distribution module results in abstracting title record documents.

18. The system of claim 13, wherein a curative transfer from the curative distribution module initiates a legal action by an attorney on behalf of the foreclosing mortgagee.

19. The system of claim 13, wherein the step of indexing comprises receiving electronic documents and automatically associating the electronic documents with a case file index.

20. The system of claim 19, further comprising automatically linking an email message from an external vendor to a case file based on the content in the email message.

21. The system of claim 13 further comprising storing electronic images of issued correspondence and postal items in the database, indexed to the case file.

22. A method for processing and analyzing a real estate title record case file, comprising:
receiving documents related to the title record case file from a referring entity;
generating electronic images of the documents related to the title record case file;
analyzing the documents by electronically reviewing the documents;
generating a worklist of issues requiring curative actions;
electronically distributing the worklist for curative actions and initiating curative actions;
certifying the title record case file if no adverse issues are identified in the title analysis and encumbrances have been cleared;
attaching an electronic signature to the case file; and
sending the results of the analysis to the referring entity.

23. The method of claim 22 further comprising the steps of repeating one or more steps of claim 22 if re-certification is required.

24. The method of claim 23, wherein the re-certification is required for an updated certification.

25. The method of claim 22 further comprising automatically sending printed copies of any adverse issues with related documentation to the referring entity.

26. The method of claim 22, wherein the curative action comprises contacting lien holders listed on the title record and verifying the status of lien on the title.

27. The method of claim 22, wherein the curative action comprises initiating litigation by an attorney.

28. The method of claim 22, wherein the documents are received electronically from an external vendor or a government entity via a communications network.

29. A method for automatic processing and analyzing a real estate title record case file, comprising:
receiving documents related to the title record case file from a referring entity;
generating electronic images of the documents related to the title record case file;
indexing the electronic images of the documents in a database, wherein upon indexing an operator may review the documents in electronic form for performing the analysis;
analyzing the documents by electronically reviewing the documents; certifying the title record case file if no adverse issues are identified in the title analysis and encumbrances have been cleared;
attaching an electronic signature to the case file; and
sending the results of the analysis to the referring entity.

30. The method of claim 29 further comprising:
generating a worklist of issues requiring curative actions; and
electronically distributing the worklist for curative actions and initiating curative actions.

31. The method of claim 29 further comprising the steps of repeating one or more steps of claim 22 if re-certification is required.

32. The method of claim 29 further comprising automatically sending printed copies of any adverse issues along with related documentation to the referring entity.

33. A method for processing and analyzing a real estate title record case file utilizing a database configured to store data related to the title record case file, a computer network coupled to the database, the computer network having one or more processors, at least one input device and one output device, a memory, a scanning and imaging device, the computer network coupled to one or more external systems via a communication network, the method comprising the steps of:
receiving documents related to the title record case file from a referring entity;
generating electronic images of the documents related to the title record case file;
indexing the electronic images of the documents in a database, wherein upon indexing an operator may review the documents in electronic form for performing the analysis;
analyzing the documents by electronically reviewing the documents; certifying the title record case file if no adverse issues are identified in the title analysis and encumbrances have been cleared;
attaching an electronic signature to the case file; and
sending the results of the analysis to the referring entity.

34. The method of claim 33 further comprising the steps of repeating one or more steps of claim 22 if re-certification is required.

35. The method of claim 33, wherein the re-certification is required for an updated certification.

36. The method of claim 32 further comprising automatically sending printed copies of any adverse issues along with related documentation to the referring entity.

37. The method of claim 32, wherein the documents include lien documents, deeds of trust, and warranty deeds.

38. The method of claim 32, wherein the documents are received electronically from an external vendor or a government entity via a communications network.

39. The method of claim 32 further comprising the step of electronically transmitting a receipt of the case file from the referring entity.
